(19) United States
(12) Patent Application Publication
(10) Pub. No.: US 2026/0081713 A1
(43) Pub. Date: Mar. 19, 2026

(54) METHODS, ARCHITECTURES, APPARATUSES AND SYSTEMS FOR STATUS REPORTING WHEN NETWORK CODING IS USED

(71) Applicant: InterDigital Patent Holdings, Inc., Wilmington, DE (US)

(72) Inventors: Justin Cray, Philadelphia, PA (US); Faris Alfarhan, Montreal (CA); Martino Freda, Laval (CA); Salah Elhoushy, LaSalle (CA); Ayesha Ijaz, Guildford (GB); Ahmed Almradi, Ipswich (GB); Pascal Adjakple, Great Neck, NY (US); Benoit Pelletier, Roxboro (CA); Ghyslain Pelletier, Montréal (CA)

(21) Appl. No.: 18/884,438

(22) Filed: Sep. 13, 2024

(51) Int. Cl. H04L 1/00; H04W 24/10

(52) U.S. Cl. CPC H04L 1/0011; H04W 24/10

(57) ABSTRACT

Procedures, methods, architectures, apparatuses, systems, devices, and computer program products using wireless transmit/receive unit (WTRU) configured for receiving configuration information indicating a minimum number of network coded packet required to recover a network coding generation; receiving a network coded packet, wherein the network coded packet comprises information indicating a network coding generation; determining that a trigger condition is met based on the configuration information; and sending a status report, based on the trigger condition being met, wherein the status report comprises information indicating a number of network coded packets received.

### BACKGROUND

The present disclosure is generally directed to the fields of communications, software and encoding, including, for example, to methods, architectures, apparatuses, systems directed to UE status reporting procedure to facilitate retransmission when network coding is used in order to reduce feedback overhead, retransmission overhead, overall transmission delay and improve cell capacity.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of a segmented-service data unit (SDU) based network coding;

FIG. 3 illustrates an example of a cross-SDU based network coding;

FIG. 4 illustrates an example of NC as a protocol in PDCP;

FIG. 5 to 11 illustrate examples of a status report;

FIG. 12 to 13 illustrate examples of a network coding generation status report;

FIG. 14 illustrates an example of a sample status control PDU;

FIG. 15 illustrates an example of a method of network coding feedback implemented by a WTRU;

FIG. 16 illustrates another example of a method of network coding feedback implemented by a WTRU; and

FIG. 17 illustrates an example of a method of transmission of a status report implemented by a WTRU.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Provided below are acronyms/abbreviations for terms and phrases commonly used in this application:
ACK Acknowledgement
AM Acknowledged mode
BS Base Station
CA Carrier Aggregation
CE Control Element
CPT Control PDU Type
CR Code Rate
CRC Cyclic Redundancy Check
DC Dual Connectivity
gNB gNodeB
HARQ Hybrid Automatic Repeat Request
IAB Integrated Access Backhaul
MAC Medium Access Control
NACK Negative-Acknowledgement
NC Network Coding
NR New Radio
PDCP Packet Data Convergence Protocol
PDU Protocol Data Unit
QoS Quality of Service
RLC Radio Link Control
RRC Radio Resource Control
SDU Service Data Unit
UE User Equipment
URLLC Ultra-Reliable and Low Latency Communications
V2X Vehicle to everything

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’.

In the following description, the following terminologies are introduced.

In this description, the UE is “configured with” refers to the scenario that the UE receives a configuration from a network node/the network (NW) (e.g., BS, gNB, other UE, etc.). For the case that the UE receive configuration from a gNB, the UE may receive a dedicated RRC configuration or SIB from the gNB. For the case that the UE receive configuration from another node, the UE may receive configuration via sidelink communication (e.g., PC5 RRC). The UE is “configured” may also refer to the scenario that the UE is hard coded to perform the action e.g., via standard specifications.

An innovative packet or innovative NC PDU is a coded packet that when received is useful for decoding the generation i.e., increases the rank of the generator matrix used to generate the NC PDUs. This implies that an innovative NC PDU is formed with coefficients that are linearly independent from coefficients used to generate other NC PDUs generated using the same generation of NC SDUs. In this disclosure, the term innovative PDU in the context of a transmitter may refer to an NC PDU that is linearly independent from NC PDUs which were previously transmitted/selected for transmission, or in the context of a receiver may refer to an NC PDU that is linearly independent from NC PDUs which were previously received.

Level of Innovativeness may refer to a usefulness of the packet when decoding a generation of packets. Some packets will only enable the decoding of a small amount of source packets while others will enable the decoding of a large amount of source packets. In this disclosure, the term more-innovative refers to an NC PDU that includes information about a larger number of source packets i.e., NC SDUs when compared to a less-innovative NC PDU. In other words, an NC PDU PDU1 is more innovative than an NC PDU PDU2, if PDU1 is coded as a linearly independent combination of K1 NC SDUs, PDU2 is coded as a linearly independent combination of K2 NC SDUs, and K1 is greater than K2. In another implementation, a threshold denoted herein K_innovative may be defined. A NC PDU PDU1 is more innovative if the NC PDU PDU1 is coded as a linearly independent combination of at least K_innovative NC SDUs. The term less-innovative NC PDU may refer to a NC PDU that will enable decoding of a smaller amount of NC SDUs when compared to a more-innovative NC PDU. In other words, an NC PDU PDU1 is less innovative than an NC PDU PDU2, if PDU1 is coded as a linearly independent combination of K1 NC SDUs, PDU2 is coded as a linearly independent combination of K2 NC SDUs, and K1 is smaller than K2. In another implementation, a NC PDU PDU1 is less innovative if PDU1 is coded as a linearly independent combination of less than K_innovative NC SDUs.

Current NC Generation may refer to a NC generation for which at least one associated NC PDU has been received and the UE awaits the arrival of more NC PDUs in order to recover the NC SDUs of the generation.

Generation Size may refer to a Number of NC SDUs that forms a generation.

Code rate (or information rate) may refer to a Ratio of the number of input packet(s) i.e., the generation size to the number of output packet i.e., X/Y.

Codeword may refer to a set of NC PDUs for a given code rate.

Fixed Code Rate may refer to a NC scheme where a code rate is fixed or pre-defined. The source NC SDUs may be either recovered from the codeword or not recovered at the receiver based on the NC PDUs generated for the code rate, and no additional NC PDU is transmitted (by the transmitter) or expected to be received (at the receiver) beyond the NC PDUs generated based on the fixed code rate. A special case of fixed rate NC is the case where all the generated NC PDU are transmitted with no expectation/use at the transmitter of a feedback from the receiver indicating whether or not the NC SDUs of the generation has been recovered.

Variable Code Rate may refer to a NC scheme where one or more code rates may be used in support of the recovery of the NC SDU that form a generation. For example, the transmitter may transmit NC PDUs according to one or more code rates, up to a maximum number of potential code rates, or until the recovery by the receiver of the NC SDU that form a generation.

Rateless Code may refer to a NC scheme where an unlimited number of code rates are assumed and may be used in support of the recovery of the NC SDUs that form a generation. For example, the transmitter may transmit NC PDUs according to one or more code rates, until the recovery by the receiver of the NC SDU that form a generation.

Adaptive Network Coding may refer to a network coding scheme that enables dynamic control, and adaptation of network coding operation over lossy channels by e.g., configuring and adapting coding parameters (e.g. generation, generation size, code rate) to meet the instantaneous delay-throughput-reliability requirements according to the radio condition changes (the channel variation) over time, accounting for the possibly loss of degree of freedom due to erasures (i.e. packet drops) or transmission errors (i.e. bit errors during transmission). In this disclosure, a feedback-based network coding scheme is one form of adaptive network coding where the transmitter adapts network coding operation based on feedback (e.g., successful decoding or failed decoding) from peer or remote node.

Retransmission may refer to a transmission of a NC PDU generated from a generation that a previously sent NC PDU with the same coefficients was generated from.

Additional transmission may refer to a transmission of a NC PDU generated from a generation that a previously sent NC PDU with the different coefficients was generated from.

In this disclosure, the UE behaviors or actions are described from the perspective of a receiving node. From that perspective, the term UE without any other qualifier means receiving UE or simply receiver. Furthermore, any solution described herein in terms of a receiving UE equally apply to any receiving node. For example: when the communication is a downlink communication, the receiving node may be for example a UE or a relay node; when the communication is an uplink communication the receiving node may be for example a RAN node (e.g., base station), a core network node, a service network node or application network node; and when the communication is a sidelink communication, the receiving node may be for example a receiving sidelink UE or a receiving sidelink relay UE.

### Example Communications System

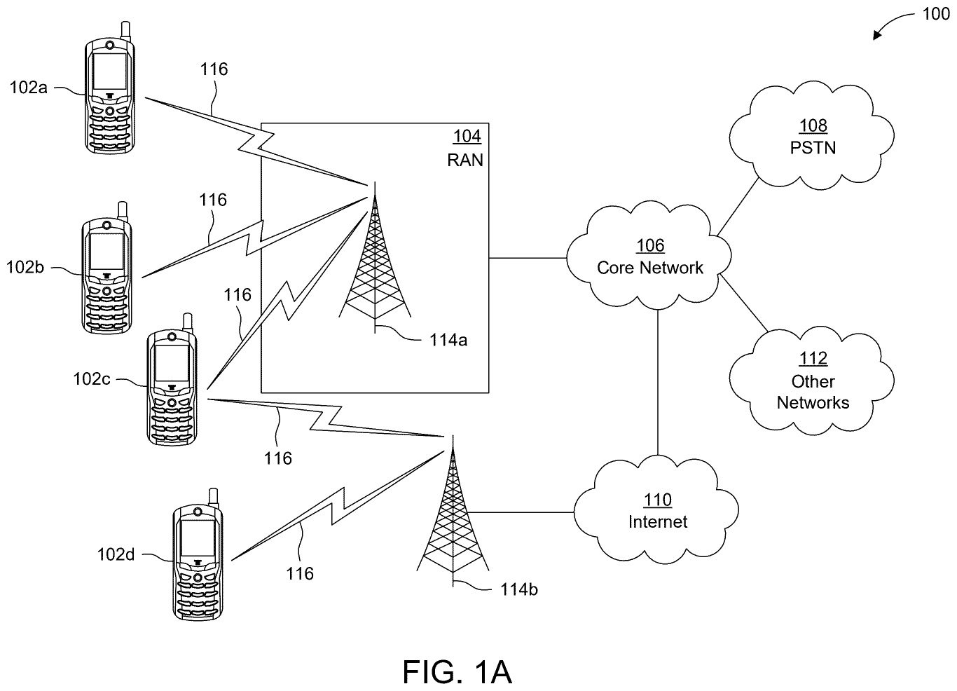

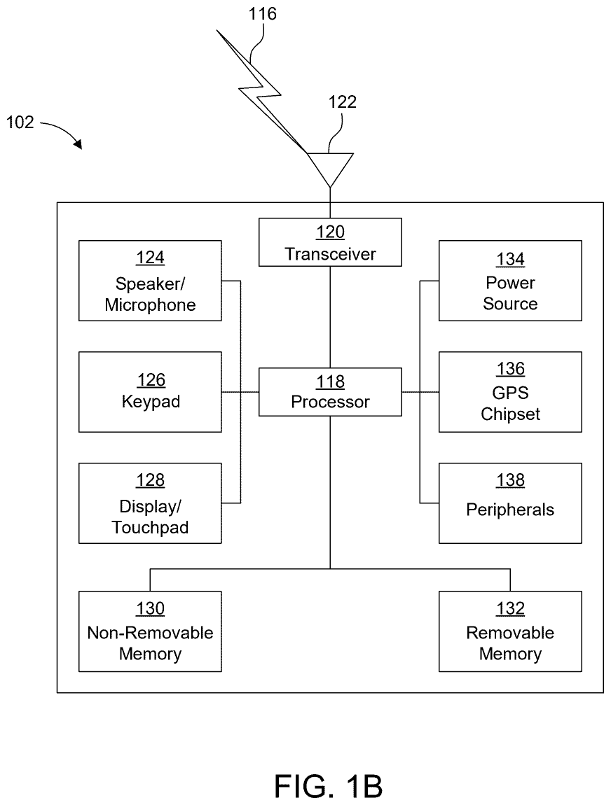

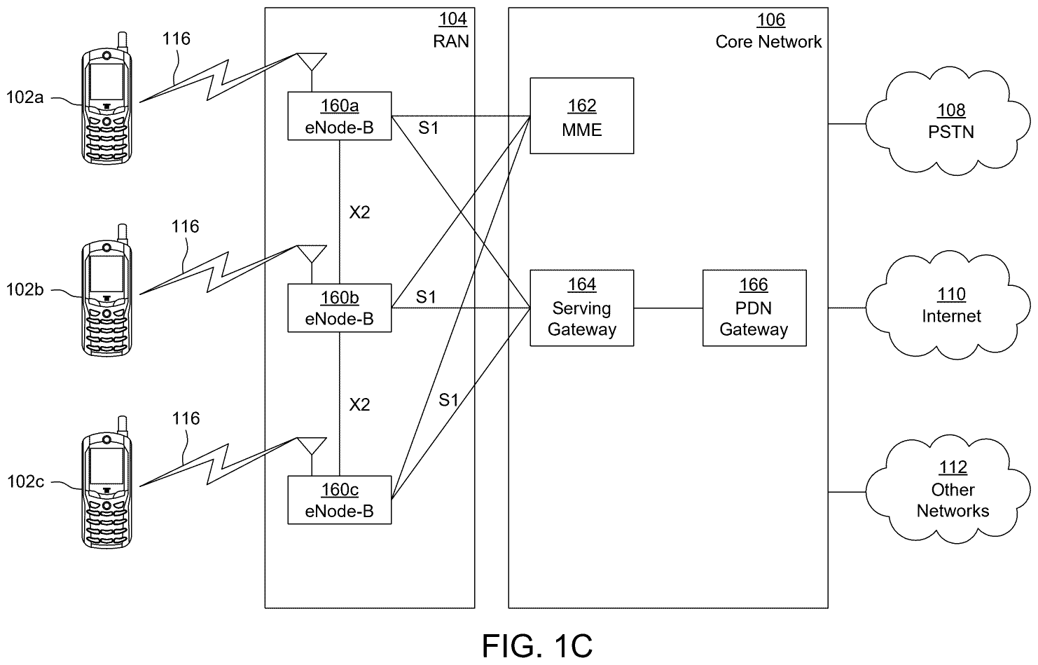

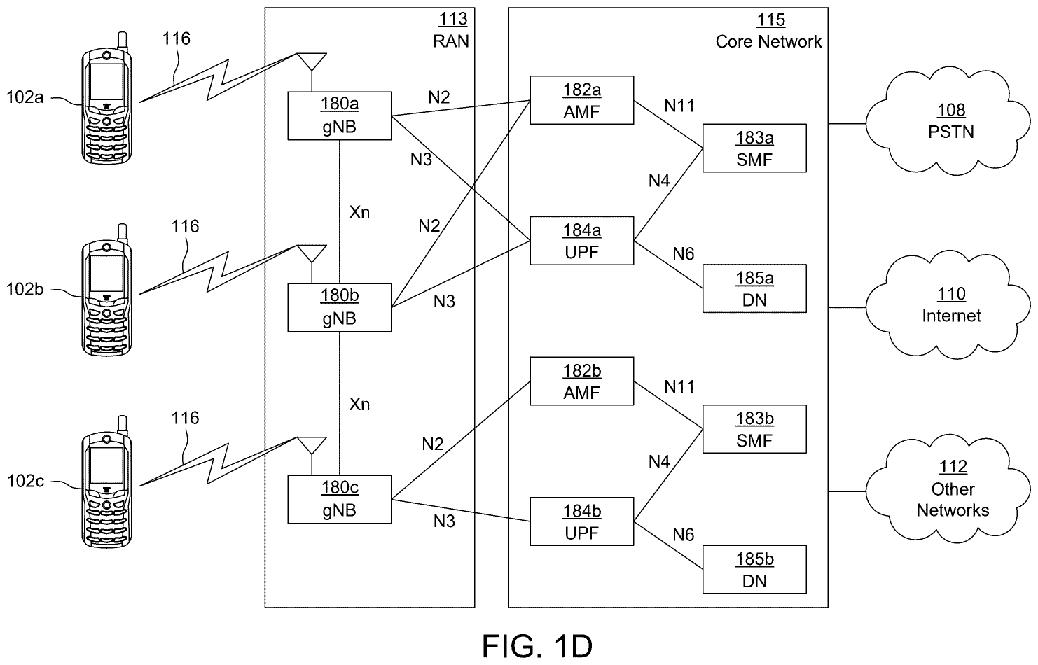

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The 5G NR design supports PDCP duplications and transmission of transport blocks (TBs) over multiple transmission and reception points (multi-TRPs) in support of ultra-reliable and low latency communication services. Considering increasing requirements in terms of various key performance metrics such as spectral efficiency, latency, reliability, data rate and the need for a concurrent support of these requirements, the use of redundancy via duplication as a solution is not efficient and not scalable.

Network coding can provide flexible redundancy coding rate for different reliability requirements and flexible split of transmission of coded packets over different transmission paths (e.g., frequency diversity, spatial diversity, code diversity) or over different time instances (for time domain diversity). Network coding may be applied with or without PDCP duplication; use of network coding may alleviate a scheduler from having to select conservative MCS transmission parameters and/or improve the allocation of other transmission resources to improve overall system performance. In reference to the existing 5G system, network coding can be used to improve efficiency for the support of multicast broadcast services, sidelink services (e.g., V2X services), enhanced mobile broadband services with the added benefits of better link efficiency, reduced latency, improved reliability, and reduced buffering requirements. Examples of deployment scenarios include CA (Carrier Aggregation), DC (Dual Connectivity), IAB (Integrated access and backhaul), sidelink including sidelink relay.

Herein, network coding is a packet processing function that transforms X input packet(s) (also called as source packets) into Y output packet(s), which is denoted as coded packet(s) hereinafter. In general X is greater or equal to 2 and Y is greater or equal to X, with the case X equal to 1 and Y equal to 1 being a special case. The X input packets being coded together form a network coding generation (denoted hereinafter a NC generation or simply a generation). A generation will have a generation identifier such as a sequence number that is used to associate packets to the generation the packets are generated from. An input packet may be an NC SDU or a segment of an NC SDU. An output packet is denoted as a NC PDU. Network coding is therefore a packet processing function that transforms X NC SDU(s) or NC SDU-segments into Y NC PDUs, wherein one or more (e.g., each) NC PDU is a different linearly independent combination of the NC SDUs or NC SDU-segments that form the NC generation being encoded into NC PDUs. In other words, a first NC PDU generated using the NC generation is obtained based on a first linear combination of the set of NC SDUs or NC SDU-segments using a first set of coding coefficients, and a second PDU generated using the NC generation is obtained based on a second linear combination of the set of NC SDUs or NC SDU-segments using a second set of coding coefficients different from the first set of coding coefficients. The first NC PDU (i.e., the first linear combination of the set of NC SDUs) and the second NC PDU (i.e., the second linear combination of the set of NC SDUs) are linearly independent. The NC PDUs associated with the same generation (i.e., generated using the same generation) may be of same or different characteristics, and therefore associated with same or different importance/priority levels. Such characteristics may be systematic packets, non-systematic packets, less-innovative non-systematic packets, more-innovative non-systematic packets, size of a NC SDU or SDU-segment of the generation for example in number of bits or octets, size of the NC PDU for example in number of bits or octets, size of a coding coefficient for example in number of bits or octets etc. Furthermore, there may be dependencies between NC PDUs of the same generation in the sense that: a) the receiver needs to correctly receive i.e. successfully decode X linearly-independent NC PDUs or more to recover the X NC SDUs; b) how many more NC PDUs or specific NC PDUs are used (e.g., needed) by the receiver to recover the X NC SDUs depends on the NC PDUs already successfully decoded by the receiver; c) the scheduling of the NC PDUs generated using the same generation is constrained by the same overall delay budget.

From the receiver perspective, when it receives at least X out of Y transmitted NC PDUs, it can recover the transmitted information i.e., the X NC SDUs or X NC SDU-segments. As a result, even if the receiver fails to successfully decode all received NC PDUs, it can still recover the NC SDUs or SDU-segments.

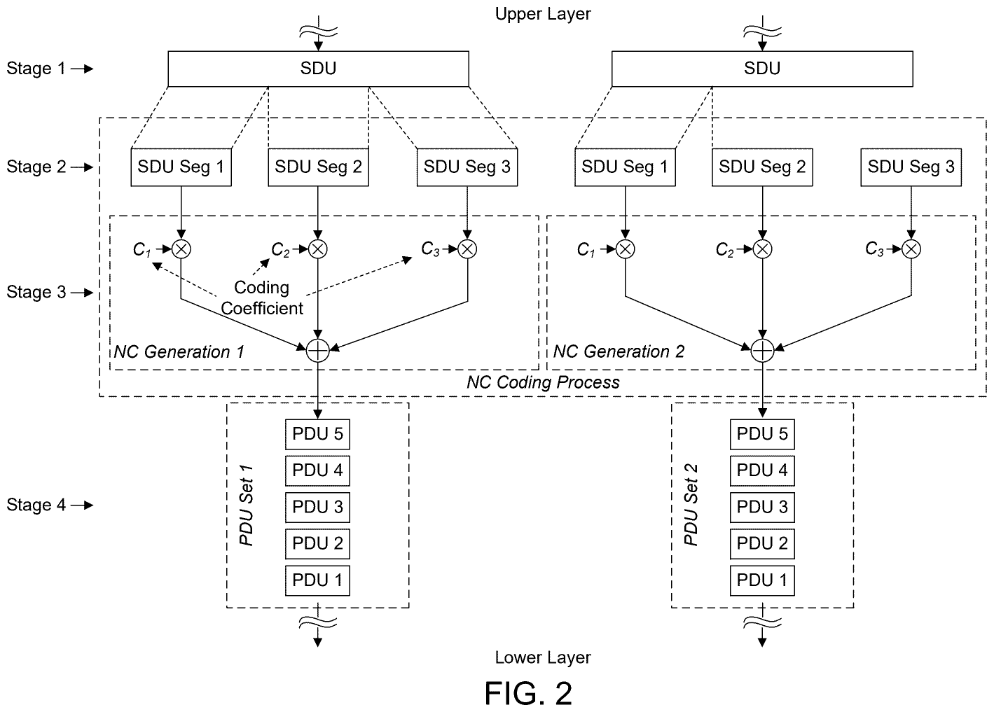

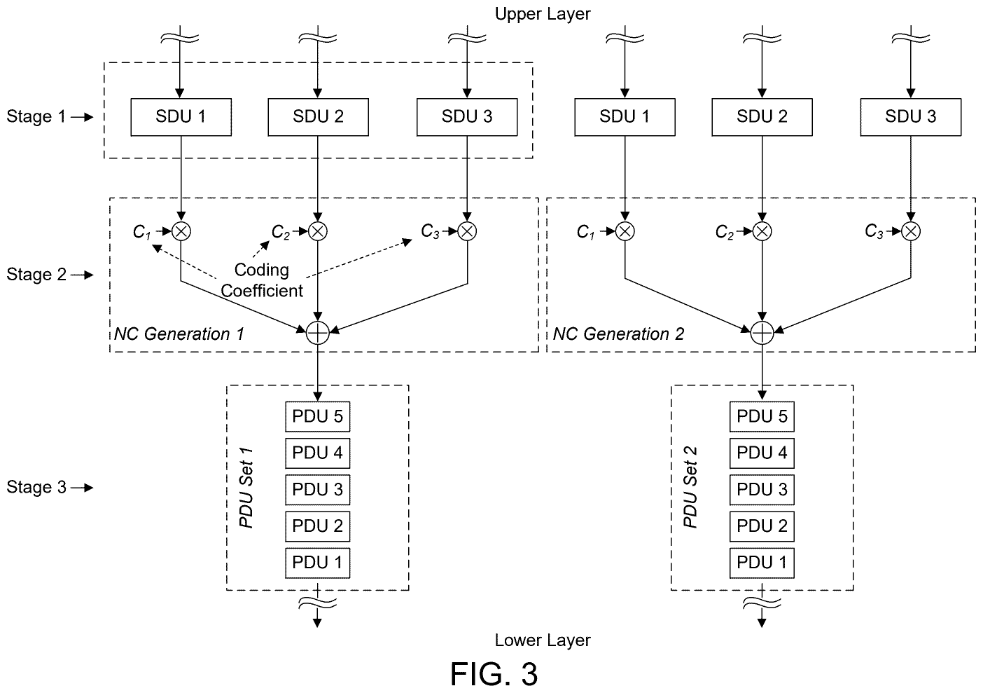

FIG. 2 shows segmented-SDU based NC in which one NC SDU is segmented and NC is performed on the segments (i.e., one-to-many mapping). FIG. 3 shows cross-SDU based NC in which NC is performed using multiple SDUs per NC generation (i.e., many-to-many mapping). Given that NC PDUs from the same generation (or different generations) may have different characteristics, enhancements to the existing PDU routing mechanisms to account for the dependencies between NC PDUs, need to be investigated.

While this description assumes by way of example, NC as protocol in PDCP (FIG. 3), it should be noted that one or more embodiments described herein apply to any packet processing method (e.g. any maximum-distance separable codes such as RaptorQ code, Reed-Solomon code, etc.) that takes X SDUs and produces Y PDUs, wherein one or more (e.g., each) PDU is a different linearly independent combination of the X SDUs, and at least X PDUs are used (e.g., needed) for the successful recovery of the X SDUs. It is assumed that the input to the coding protocol/function is perfectly reliable, i.e., at the receiver, the received PDU would have successfully passed CRC check before being processed by the coding protocol/function located in a protocol that is post-CRC-check processing (e.g., above HARQ, including the application layer). Furthermore, it is assumed network coding as defined herein may be applied to packets that have been already processed through network coding i.e., NC SDUs may be network coded packets e.g., for scenarios with recoding where network coding is applied at more than one node located in the processing path of a packet.

While this description assumes by way of example that the NC feedback/retransmission protocols will be implemented in the RLC and/or PDCP layer(s). However, it should be noted that one or more embodiments described herein apply herein apply to any feedback/retransmission protocols when NC is used and may be utilized in any protocol layer.

Herein, the term NC PDU header of an NC PDU will be used in reference to a header information specific to the NC protocol that generates the NC PDU, or a header information of any other protocol that either implements NC or is part of the upper layer protocols or lower layer protocols relative to the protocol that implements NC.

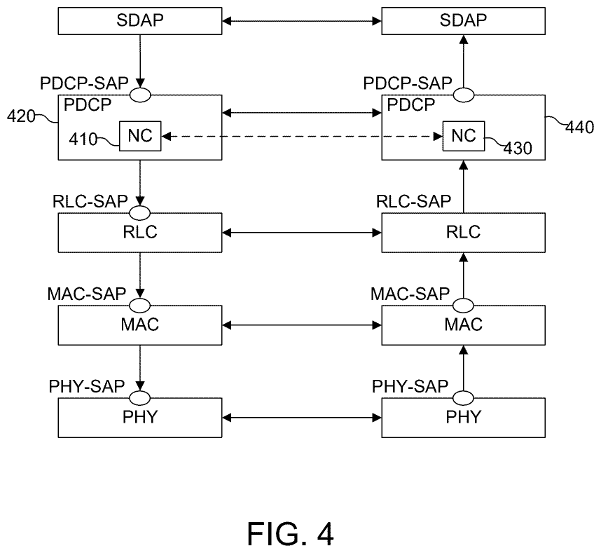

FIG. 4 is a diagram illustrating an example of NC as a protocol in PDCP. As illustrated, the NC encoder 410 may be operating at the PDCP layer transmitter 420. The NC decoder 430 may be operating at the PDCP layer receiver 440.

When network coding is implemented above HARQ, for e.g., in PDCP (as shown in FIG. 4), there may be an increase in status report overhead to facilitate retransmission, and overall transmission delay since Y packets are transmitted instead of X with Y≥X. Furthermore, network coding may use (e.g., require) a feedback mechanism to further enhance performance when feedback delay is acceptable for the application delay requirement. Therefore, enhancements are desirable for reduction of: status report or feedback overhead, retransmission overhead, and/or overall transmission delay.

Methods and apparatus are provided for allowing a receiving node to perform status reporting to reduce status reporting overhead, improve cell capacity and meet the delay budget. Furthermore, this description provides means to provide feedback for the network to adapt the NC (e.g., for retransmissions or new transmissions).

Methods and apparatus are provided for allowing a WTRU (e.g., UE) to determine whether to transmit a status report based on NC PDU reception and new conditions associated with the NC configuration. The WTRU (e.g., UE) may report additional information in the status report to the network so that the network can further adjust the NC coding.

The WTRU (e.g., UE) may be configured with NC related metrics including one or more of the following: (1) NC code rate; (2) Minimum number of NC PDUs required to recover the NC SDUs of the NC Generation (denoted as X in the following) i.e. NC generation size; or (3) recoveryRemainingTimeThreshold, a time duration from the time a new generation is initialized until the time instant when a status report is triggered if the generation has not been successfully recovered.

The WTRU (e.g., UE) may receive a NC PDU and may determine it is within the receiving window based on information in the NC PDU header and a receiving window maintained by the WTRU (e.g., UE). For example, if the PDU's SN is in a specified range of NC PDUs generated from NC generations that have not been decoded.

The WTRU (e.g., UE) may determine if the received NC PDU belongs to a new generation or an existing generation (e.g., based on the NC PDU generation identifier). For example, if the received NC PDU belongs to a new generation, the WTRU (e.g., UE) may perform one or more of the following: instantiate a new generation, associate the received NC PDU with the new generation, initialize a counter for time duration (e.g., counterTimeDuration) for triggering a status report, initialize a counter for the number of received NC PDU(s). For example, if the received NC PDU belongs to an existing generation, the WTRU (e.g., UE) may perform one or more of the following: associate the NC PDU to the corresponding NC generation, update the counter for time duration (e.g., counterTimeDuration), update the counter for the number of received NC PDU(s).

The WTRU (e.g., UE) may evaluate trigger conditions for sending a status report as a function of new conditions associated with the NC configuration. Example of triggers may comprise a condition wherein the counter for time duration (e.g., counterTimeDuration) passes a time duration threshold (e.g., recoveryRemainingTimeThreshold) and X NC PDUs of the generation have not been received. Example of triggers may comprise a condition wherein a reception of more than X NC PDUs generated using the generation has occurred. The WTRU (e.g., UE) may send a status report to provide information that the network uses to enable changes to the NC code or other NC configuration parameters and stop sending NC PDUs generated using this generation. The WTRU (e.g., UE) may be configured with a prohibit timer to control how often the WTRU (e.g., UE) send the STATUS PDU.

The WTRU (e.g., UE) may determine that the status report should be sent. The WTRU (e.g., UE) may transmit the status report with information about one or more of NC PDUs that are detected to be lost, one or more NC PDUs that are successfully received, the number of missing NC PDUs for a successful recovery of the NC SDUs that forms the NC generation, the coding coefficients to be used for a requested NC PDU, and/or recommended network coding parameters.

For example, the status report may report the highest generation number where X NC PDUs from that generation have been received. This implicitly acknowledges all generations with a generation number less than or equal to this value unless they are (e.g., explicitly) negatively acknowledged.

For example, the status report may report one or more generations, wherein at least X NC PDUs is received for one or more (e.g., each) reported generation, using a bitmap of the length of the generation reassembly window. One or more (e.g., each) bit may indicate if at least X NC PDUs from the corresponding generation have been received. The WTRU (e.g., UE) may also report specific NC PDU counts for one or more (e.g., each) generation where X NC PDUs have not been received.

For example, the status report may report feedback by requesting NC PDU(s) coded with specific NC coefficients. If the WTRU (e.g., UE) receives X linearly independent NC PDUs generated using the same generation.

The WTRU (e.g., UE) may update the lower edge of the receiving window to be the first PDU of the next generation to be received.

A WTRU (e.g., UE) receiving data from the network may be configured with a NC configuration from the network. The NC configuration may be configured by a RRC message, Downlink Control Indicator (DCI), MAC Control Element (CE), layer 1 and/or layer 2 signal, or pre-defined in the specification.

The NC configuration may contain one or more of the following: (1) a parameter (X) that may indicate the number of NC SDUs per NC generation; (2) a parameter that indicates the number of NC PDUs expected to be received per NC generation (Y) if all transmitted packets are received; (3) a parameter that indicates code rate. For example, if fixed NC code rate is used. In one implementation, it could be a ratio X/Y. In another implementation it could be the numbers X and/or Y; (4) a parameter that indicates two or more code rates. For example, if a variable code rate is used. In one implementation, it could be a list of ratios X/Y. In another implementation, it could be a list of set numbers, wherein one or more (e.g., each) set comprise of X and/or Y; (5) a parameter: a time duration threshold (e.g., recoveryRemainingTimeThreshold) that indicates a time duration from the time a new generation is initialized until the time instant when a status report is triggered if the generation has not been successfully recovered; or (6) conditions for selecting a status report format(s) to be used as a function of one or more of the following: number of NC PDUs received, NC PDU characteristics, remaining delay budget, NC configuration and radio related measurements.

The NC configuration may be a radio bearer/a PDCP specific configuration. That is, for different PDCP entities/radio bearers configured with the NC protocol respectively, the network may provide individual NC configurations for one or more (e.g., each) of the configured NC protocols. More generally, NC configuration granularity may be at DRB level, SRB level, logical channel level, QOS flow level, application layer PDU or PDU set level, transport bearer level, service data flow level, etc., for example depending on the location of the protocol where NC.

The WTRU (e.g., UE) may be configured with different status report formats that can be used to report the status of the received NC PDUs. For instance, the WTRU (e.g., UE) may be configured to send a status report indicating any of: (1) ACK/NACK status of an NC generation; (2) the number of received NC PDUs from a generation; (3) the number of missing NC PDUs from a generation; (4) the number of received NC PDUs from an NC PDU set (e.g., number of received NC PDUs with specific characteristics); (5) the number of missing NC PDUs from an NC PDU set (e.g., number of missing NC PDUs with specific characteristics); (6) ACK/NACK status of one or more (e.g., each) NC PDU within a generation; (7) ACK/NACK status of one or more (e.g., each) NC PDU within an NC PDU set (e.g., ACK/NACK status of PDUs with certain characteristics, e.g., systematic packets); (8) the number of extra packets required for a generation; or (9) the number of extra packets required from a certain NC PDU set (e.g., number of required packets with certain characteristics).

The status report may comprise a combination of above, for example, the status report may indicate the number of received NC PDUs for a certain NC PDU set and indicate the ACK/NACK status of NC PDUs from another NC PDU set; and/or the status report may indicate the number of missing NC PDUs for a certain NC PDU set and indicate the ACK/NACK status of PDUs from another NC PDU set.

The WTRU (e.g., UE) may determine if the received NC PDU belongs to a new generation or an existing generation (e.g., based on the NC PDU generation identifier).

The WTRU (e.g., UE) may determine what generation an NC PDU is associated with, and may update associated counts. The WTRU (e.g., UE) may determine when an NC PDU is missing, and may update associated counts.

The WTRU (e.g., UE) may determine what generation a received NC PDU is generated from based on information available in the header fields of the various protocol layers (RLC, PDCP, etc.) and/or a dedicated header for the NC protocol as well as a receiving window maintained by the WTRU (e.g., UE).

For example, in the case where the WTRU (e.g., UE) may perform the feedback functions in the RLC layer, the WTRU (e.g., UE) may determine what generation the RLC PDU is generated from based on information available in one or more of the following: the RLC header, upper layer header (e.g., PDCP header), and/or a NC protocol added in the upper layer where NC is performed.

For example, in the case where the WTRU (e.g., UE) may perform the feedback functions in the PDCP layer, the WTRU (e.g., UE) may determine what generation the PDCP PDU is generated from based on information available in one or more of the following: the PDCP header and/or a NC protocol added in the upper layer where NC is performed.

According to some embodiments, the header(s) mentioned above will (e.g., explicitly) indicate which generation the NC PDU was generated from via a generation identifier, generation sequence number, etc.

According to some embodiments, the WTRU (e.g., UE) may determine the generation using a PDU sequence number included in the header and one or more of the following: the generation size, the NC code rate and the number of NC PDUs expected to be received (Y) for the generation.

According to some embodiments, the WTRU (e.g., UE) may use the generation size (X) and the NC code rate configured by the network to determine the number of NC PDUs for one or more (e.g., each) generation. The WTRU (e.g., UE) (e.g., then) may determine which generation the NC PDU is generated from based on the total number of NC PDUs for one or more (e.g., each) generation and the PDU sequence number.

According to some embodiments, the WTRU (e.g., UE) may use the generation size (X) and the number of NC PDUs expected to be received per generation (Y) as configured by the network to determine the number of NC PDUs for one or more (e.g., each) generation. The WTRU (e.g., UE) (e.g., then) may determine which generation the NC PDU is generated from based on the total number of NC PDUs for one or more (e.g., each) generation and the PDU sequence number.

According to some embodiments, the WTRU (e.g., UE) may use the NC configuration that is configured per resource (path, bearer, etc.) to determine which generation the NC PDU is generated from. The WTRU (e.g., UE) may determine which generation the NC PDU is generated from based on what resource it was received on, the number of NC PDUs received on that resource and the NC configuration for that resource.

According to some embodiments, the WTRU (e.g., UE) may use the counters described below to determine the number of NC PDUs received for all previous generations and the number of NC PDUs expected to be received for the current generation(s) (Y) to determine the number of NC PDUs in the current generation(s). The WTRU (e.g., UE) (e.g., then) may use the NC PDU's sequence number to associate the NC PDU to a certain generation.

According to some embodiments, a WTRU (e.g., UE) may receive indication in a control PDU or a PDU header about the number of NC PDUs transmitted from one or more (e.g., each) generation. The information may be received periodically or periodically. The WTRU (e.g., UE) may determine which generation the received NC PDU is generated from based on the indication of number of NC PDUs, the WTRU (e.g., UE) may be expected to receive one or more (e.g., each) generation and the PDU sequence number.

Once the generation has been determined, the NC context may be updated as described below.

A NC PDU may be declared missing if it is not received in a certain timeframe. According to some embodiments, the WTRU (e.g., UE) may start a timer/time period if a NC PDU is not received and the next NC PDU in the sequence (based on the PDU sequence number) is received. Once this timer expires the NC PDU may be declared missing and the relevant counter may be updated. According to some embodiments, a timer/time period may be specified for the entire generation. All NC PDUs not received at the end of the timer/time period are declared missing.

According to some embodiments, the WTRU (e.g., UE) may determine what generation the missing NC PDU is generated from based on one or more of the following: PDU sequence number, the configured generation size (X) and the configured NC CR. The WTRU (e.g., UE) may use these parameters to determine the number of NC PDUs expected to be received per generation and maps the missing PDU's sequence number to a generation.

For example, in the case where the WTRU (e.g., UE) may perform the feedback functions in the RLC layer, the WTRU (e.g., UE) may determine what generation the missing RLC PDU is generated from based on its RLC SN, the generation size (X) and the NC CR. The generation size and NC CR are configured by the network. The WTRU (e.g., UE) may use these parameters to determine the number of NC PDUs expected to be received per generation and maps the missing PDU's sequence number to a generation.

For example, in the case where the WTRU (e.g., UE) may perform the feedback functions in the PDCP layer, the WTRU (e.g., UE) may determine what generation the missing PDCP PDU is generated from based on its PDCP SN, the generation size and the NC CR. The generation size and NC CR are configured by the network.

According to some embodiments, the WTRU (e.g., UE) may determine what generation the missing NC PDU is generated from based on one or more of the following: the PDU sequence number and the number of NC PDUs expected to be received per generation (Y) as configured by the network.

For example, in the case where the WTRU (e.g., UE) may perform the feedback functions in the RLC layer, the WTRU (e.g., UE) may determine what generation the missing RLC PDU is generated from based on its RLC SN and the configured number of RLC PDUs expected to be received per generation (Y) by the network. The WTRU (e.g., UE) may use these parameters to determine the number of NC PDUs expected to be received per generation and maps the missing PDU's sequence number to a generation.

For example, in the case where the WTRU (e.g., UE) may perform the feedback functions in the PDCP layer, the WTRU (e.g., UE) may determine what generation the missing PDCP PDU is generated from based on its PDCP SN and the configured number of PDCP PDUs expected to be received per generation (Y) by the network. The WTRU (e.g., UE) may use these parameters to determine the number of NC PDUs expected to be received per generation and maps the missing PDU's sequence number to a generation.

According to some embodiments, the WTRU (e.g., UE) may determine what generation the missing NC PDU is associated with based on the PDU's sequence number.

For example, if the NC PDU next in the sequence (PDU sequence number just after the missing NC PDU's sequence number) is part of the same generation as the NC PDU received right before the missing NC PDU than the missing NC PDU is associated with the same generation as the NC PDU next in the sequence.

Once the generation has been determined, the NC context may be updated as described below.

The WTRU (e.g., UE) may update a NC Context associated with one or more (e.g., each) generation.

If the received NC PDU belongs to a new generation, the WTRU (e.g., UE) may perform one or more of the following: instantiate a new generation, associate the received NC PDU with the new generation, initialize a counter for time duration (e.g., counterTimeDuration) for triggering a status report, initialize a counter for the number of received NC PDU(s).

If the received NC PDU is the first NC PDU associated with a specific generation, the WTRU (e.g., UE) initializes a context for the generation. The context may include one or more of: (1) a generation identifier that identifies this new generation. For example, the generation identifier may be a generation sequence number carried by the received NC PDU; (2) a counterTimeDuration, that counts the elapsed time duration since the initialization of this generation. Set counterTimeDuration to zero, instead of maintaining the variable counterTimeDuration, a timer (generationRecoveryTimer) may be set to the time duration threshold (e.g., recoveryRemainingTimeThreshold) and store into the context; (3) a counter for the number of received NC PDUs (genPDUReceiveCount) that may be initialized to 1 once the first NC PDU is received; (4) a counter for the number of missing NC PDUs (genPDUMissingCount) that Initialized to 0; (5) a list of the PDU sequence numbers of all NC PDUs that are received for this generation (genPDUReceiveList) that may be initialized to include the PDU sequence number of the received NC PDU; or (6) a list of the missing PDU sequence numbers that may be initialized as empty (genPDUMissingList).

If the received NC PDU belongs to an existing generation, the WTRU (e.g., UE) may perform one or more of the following: associate the NC PDU to the corresponding NC generation, update the counter counterTimeDuration, update the counter for the number of received NC PDU(s).

If the received NC PDU is not the first NC PDU associated with a specific generation, the WTRU (e.g., UE) may update the context for the generation that the NC PDU is generated from. The context may include any of: a counter for the number of received NC PDUs (genPDUReceiveCount) may be incremented by 1; (2) if the received NC PDU was previously declared missing, decrement the counter for the number of missing NC PDUs (genPDUMissingCount) by 1; or (3) the PDU sequence number of the received NC PDU may be added to a list of the PDU sequence numbers of all NC PDUs that are received for this generation (genPDUReceiveList).

If a NC PDU is declared missing, the WTRU (e.g., UE) may update the generation context.

If a NC PDU is declared missing, the WTRU (e.g., UE) may perform any of the following actions: (1) a counter counting the number of missing NC PDUs (genPDUMissingCount) may be incremented by 1; or (2) the PDU sequence number of the missing NC PDU may be added to a list of the PDU sequence numbers of all NC PDUs that are declared missing for this generation (genPDUReceiveList).

The WTRU (e.g., UE) may reset/delete the context once X NC PDUs have been received.

This NC generation context or struct including all the counters would be reset/deleted once the NC generation has been recovered.

According to some embodiments, the WTRU (e.g., UE) may store these counters and use them to manage the NC configuration. Whether the WTRU (e.g., UE) deletes the NC generation context or not may depend on whether the WTRU (e.g., UE) is configured to report feedback for NC configuration adaptation. If the WTRU (e.g., UE) is configured to report feedback e.g., number of NC PDUs more than X, number of NC generations for which more than a certain number of NC PDUs are received within a certain preconfigured time etc., the WTRU (e.g., UE) may not delete/reset the NC generation context even upon receiving X NC PDUs.

According to some embodiments, a trigger may comprise a condition wherein the counter for time duration (e.g., counterTimeDuration) passes recoveryRemainingTimeThreshold, and X NC PDUs of the generation have not been received.

If the received NC PDU belongs to a new generation, the WTRU (e.g., UE) may perform one or more of the following: instantiate a new generation, associate the received NC PDU with the new generation, initialize a counter for time duration (e.g., counterTimeDuration) for triggering a status report, initialize a counter for the number of received NC PDU(s).

The WTRU (e.g., UE) may be configured with conditions to start a timer/start a time period as described above (generationRecoveryTimer or counterTimeDuration). When the counterTimeDuration timer/time duration expires the WTRU (e.g., UE) should send a status report.

If the timer/time period is stopped before it expires the WTRU (e.g., UE) does not send a status report. The WTRU (e.g., UE) may be configured to stop the timer/timer period (e.g., counterTimeDuration or generationRecoveryTimer) associated with a NC generation when a specified number of NC PDU(s) are received:

According to some embodiments, the timer may be stopped or the time period ends if X NC PDUs generated using a NC generation are received.

For example, in the case where the WTRU (e.g., UE) may perform the feedback functions in the RLC layer and segmentation is not used, the timer may be stopped when X RLC PDUs generated using a NC generation are received.

For example, in the case where the WTRU (e.g., UE) may perform the feedback functions in the RLC layer and RLC segmentation is used, the WTRU (e.g., UE) may stop the timer if sufficient RLC PDUs are received to reassemble X RLC SDUs generated from the generation that triggered the timer.

For example, in the case where the WTRU (e.g., UE) may perform the feedback functions in the PDCP layer, the timer may be stopped when X PDCP PDUs generated using a NC generation are received.

At this point, the WTRU (e.g., UE) can recover the NC generation. If this timer value or the time period (generationRecoveryTimer or counterTimeDuration) is greater than recoveryRemaining Time Threshold before X NC PDUs are received/reassembled the WTRU (e.g., UE) may trigger the status report.

According to some embodiments, the timer may be stopped or the time period ends if X−n NC PDUs generated using a NC generation are received where n may be a parameter configured by the network.

For example, in the case where the WTRU (e.g., UE) may perform the feedback functions in the RLC layer and segmentation is not used, the timer may be stopped when X−n RLC PDUs generated using a NC generation are received where n may be a parameter configured by the network.

For example, in the case where the WTRU (e.g., UE) may perform the feedback functions in the RLC layer and RLC segmentation is used, the WTRU (e.g., UE) may stop the timer if sufficient RLC PDUs are received to reassemble X−n RLC SDUs generated from the generation that triggered the timer where n may be a parameter configured by the network.

For example, in the case where the WTRU (e.g., UE) may perform the feedback functions in the PDCP layer, the timer may be stopped when X−n PDCP PDUs generated using a NC generation are received where n may be a parameter configured by the network.

At this point, the WTRU (e.g., UE) cannot recover the NC generation but has received a threshold value of packets. If this timer value or the time period is greater than the time duration threshold (e.g., recoveryRemainingTimeThreshold) before X−n NC PDUs are received/reassembled the WTRU (e.g., UE) may trigger the status report.

According to some embodiments, a trigger may comprise a condition wherein extra NC PDUs are received for a certain generation(s).

For example, in the case where reception of more than X NC PDUs generated using the generation has occurred, the WTRU (e.g., UE) may send a status report to indicate the BS can stop sending NC PDUs generated using this generation and/or adjust the NC code rate for future transmission.

According to some embodiments, the WTRU (e.g., UE) may be configured to transmit the status report when more than X innovative NC PDUs generated using the same generation are received.

According to some embodiments, the WTRU (e.g., UE) may send the status report if the received NC PDU is generated from a generation that X previously received NC PDUs were generated from.

For example, in the case where the WTRU (e.g., UE) may perform the NC feedback functions in the RLC layer and RLC segmentation is not performed, the WTRU (e.g., UE) may send the RLC STATUS PDU if the received RLC PDU is generated from a generation that X previously received RLC PDUs were generated from.

For example, in the case where the WTRU (e.g., UE) may perform the NC feedback functions in the RLC layer and RLC segmentation is performed, the WTRU (e.g., UE) may send the RLC STATUS PDU if the received RLC PDU is a segment of an NC PDU/RLC SDU that is generated from a generation that X previously received NC PDUs (reassembled RLC SDUs) were generated from.

For example, in the case where the WTRU (e.g., UE) may perform the NC feedback functions in the PDCP layer the WTRU (e.g., UE) may send PDCP Status Report if the received PDCP PDU is generated from a generation that X previously received PDCP PDUs were generated from.

According to some embodiments, the WTRU (e.g., UE) may send the status report if the received NC PDU is generated from a generation that X+n previously received NC PDUs were generated from where n may be a parameter configured by the network where n≥0.

For example, in the case where the WTRU (e.g., UE) may perform the NC feedback functions in the RLC layer and RLC segmentation is not performed, the WTRU (e.g., UE) may send the RLC STATUS PDU if the received RLC PDU is generated from a generation that X+n previously received RLC PDUs were generated from where n may be a parameter configured by the network.

For example, in the case where the WTRU (e.g., UE) may perform the NC feedback functions in the RLC layer and RLC segmentation is performed, the WTRU (e.g., UE) may send the RLC STATUS PDU if the received RLC PDU is a segment of an NC PDU/RLC SDU that is generated from a generation that X+n previously received NC PDUs (reassembled RLC SDUs) were generated from where n may be a parameter configured by the network.

For example, in the case where the WTRU (e.g., UE) may perform the NC feedback functions in the PDCP layer the WTRU (e.g., UE) may send PDCP Status Report if the received PDCP PDU is generated from a generation that X+n previously received PDCP PDUs were generated from where n may be a parameter configured by the network.

According to some embodiments, the WTRU (e.g., UE) may trigger a status report if X innovative NC PDUs are received for a generation and the WTRU (e.g., UE) may expect to receive a number of NC PDUs in the future above a configured threshold value (Xₜₕ).

According to some embodiments, the WTRU (e.g., UE) may be configured to transmit the status report when more than X NC PDUs generated using the same generation are received within a time bound configured by the network.

According to some embodiments, the WTRU (e.g., UE) may send the status report if the received NC PDU is generated from a generation that X+n previously received NC PDUs were generated from where n may be a parameter configured by the network within a time bound configured by the network where n≥0.

For example, in the case where the WTRU (e.g., UE) may perform the NC feedback functions in the RLC layer and RLC segmentation is not performed, the WTRU (e.g., UE) may send the RLC STATUS PDU if the received RLC PDU is generated from a generation that X+n previously received RLC PDUs were generated from where n may be a parameter configured by the network within a time bound configured by the network.

For example, in the case where the WTRU (e.g., UE) may perform the NC feedback functions in the RLC layer and RLC segmentation is performed, the WTRU (e.g., UE) may send the RLC STATUS PDU if the received RLC PDU is a segment of an NC PDU/RLC SDU that is generated from a generation that X+n previously received NC PDUs (reassembled RLC SDUs) were generated from where n may be a parameter configured by the network within a time bound configured by the network.

For example, in the case where the WTRU (e.g., UE) may perform the NC feedback functions in the PDCP layer the WTRU (e.g., UE) may send PDCP Status Report if the received PDCP PDU is generated from a generation that X+n previously received PDCP PDUs were generated from where n may be a parameter configured by the network within a time bound configured by the network.

According to some embodiments, the WTRU (e.g., UE) may send the status report if X+n NC PDUs generated using the same generation are received for a certain number of generations (N) within a time bound where n and N are configured by the network.

For example, in the case where the WTRU (e.g., UE) may perform the NC feedback functions in the RLC layer and RLC segmentation is not performed, the WTRU (e.g., UE) may send the RLC STATUS PDU if upon reception of the RLC PDU there will be N generations where X+n RLC PDUs have been received within a time bound where n and N are configured by the network.

For example, in the case where the WTRU (e.g., UE) may perform the NC feedback functions in the RLC layer and RLC segmentation is performed, the WTRU (e.g., UE) may send the RLC STATUS PDU if the received RLC PDU is a segment of an NC PDU/RLC SDU that upon reassembly of the RLC SDU/NC PDU there will be N generations where X+n NC PDUs (including reassembled RLC SDUs) have been received within a time bound where n and N are configured by the network.

For example, in the case where the WTRU (e.g., UE) may perform the NC feedback functions in the PDCP layer, the WTRU (e.g., UE) may send a PDCP Status Report if upon reception of the PDCP PDU there will be N generations where X+n PDCP PDUs have been received within a time bound where n and N are configured by the network.

According to some embodiments, a trigger may comprise a condition wherein more than Y−X NC PDUs are determined missing for a certain generation.

According to some embodiments, the WTRU (e.g., UE) may be configured to send a status report when more than Y−X NC PDUs have been declared missing. Individual NC PDUs may be declared missing by using a timer/time period that may determine when a packet missing. This timer/time period may start when the next NC PDU in the sequence is received or a segment of a NC PDU is received if NC PDUs are being segmented. The length of this timer/time period is configured by the network. Multiple NC PDUs associated with a generation may be declared missing through this method.

According to some embodiments, the WTRU (e.g., UE) may send the status report if more than Y−X NC PDUs have been declared missing (timer expired).

For example, in the case where the WTRU (e.g., UE) may perform the NC feedback functions in the RLC layer and RLC segmentation is not performed, the WTRU (e.g., UE) may send the status report if more than Y−X NC PDUs have been declared missing (missing packet timer expired for Y−X packets).

For example, in the case where the WTRU (e.g., UE) may perform the NC feedback functions in the RLC layer and RLC segmentation is performed, the WTRU (e.g., UE) may send the status report the missing packet timer expires and not all segments of an RLC SDU are received for Y−X RLC SDUs (NC PDUs).

For example, in the case where the WTRU (e.g., UE) may perform the NC feedback functions in the PDCP layer the WTRU (e.g., UE) may send the status report if more than Y−X PDCP PDUs have been declared missing based on the missing packet timer for one or more (e.g., each) PDCP PDU.

According to some embodiments, the WTRU (e.g., UE) may send the status report if more than Y−X−n NC PDUs have been declared missing (missing packet timer expired) where n may be a parameter configured by the network within a time bound configured by the network and n≥0.

For example, in the case where the WTRU (e.g., UE) may perform the NC feedback functions in the RLC layer and RLC segmentation is not performed, the WTRU (e.g., UE) may send the status report if more than Y−X−n NC PDUs have been declared missing (missing packet timer expired for Y−X−n packets) where n may be a parameter configured by the network and n≥0 within a time bound configured by the network.

For example, in the case where the WTRU (e.g., UE) may perform the NC feedback functions in the RLC layer and RLC segmentation is performed, the WTRU (e.g., UE) may send the status report if the missing packet timer expires and not all segments of an RLC SDU are received for Y−X−n RLC SDUs (NC PDUs) where n may be a parameter configured by the network and n≥0 within a time bound configured by the network.

For example, in the case where the WTRU (e.g., UE) may perform the NC feedback functions in the PDCP layer the WTRU (e.g., UE) may send the status report if more than Y−X PDCP PDUs have been declared missing based on a timer for one or more (e.g., each) PDCP PDU where n may be a parameter configured by the network and n≥0 within a time bound configured by the network.

According to some embodiments, a trigger may comprise a condition wherein NC PDUs of certain characteristics are missing or not received.

According to some embodiments the WTRU (e.g., UE) may be configured to send a status report when more than n NC PDUs of a certain characteristic have been declared missing (as defined per missing packet timer expiring) where n may be a parameter configured by the network and n≥0.

For example, in the case where the WTRU (e.g., UE) may perform the NC feedback functions in the RLC layer and RLC segmentation is not performed, the WTRU (e.g., UE) may send the status report if more than Y−X−n NC PDUs of a certain characteristic have been declared missing (missing packet timer expired for Y−X−n packets) where n may be a parameter configured by the network and n≥0.

For example, in the case where the WTRU (e.g., UE) may perform the NC feedback functions in the RLC layer and RLC segmentation is performed, the WTRU (e.g., UE) may send the status report if the missing packet timer expires and not all segments of an RLC SDU are received for Y−X−n RLC SDUs (NC PDUs) of a certain NC characteristic where n may be a parameter configured by the network and n≥0.

For example, in the case where the WTRU (e.g., UE) may perform the NC feedback functions in the PDCP layer the WTRU (e.g., UE) may send the status report if more than Y−X PDCP PDUs have been declared missing based on the missing packet timer for one or more (e.g., each) PDCP PDU of a certain NC characteristic where n may be a parameter configured by the network and n≥0.

According to some embodiments, the WTRU (e.g., UE) may send the status report if the received NC PDU is generated from a generation that n previously received NC PDUs of similar or identical characteristic (importance, innovativeness, etc.) were generated from where n may be a parameter configured by the network within a time bound configured by the network where n≥0.

For example, in the case where the WTRU (e.g., UE) may perform the NC feedback functions in the RLC layer and RLC segmentation is not performed, the WTRU (e.g., UE) may send the RLC STATUS PDU if the received RLC PDU is generated from a generation that n previously received RLC PDUs of similar or identical characteristic (importance, innovativeness, etc.) were generated from where n may be a parameter configured by the network within a time bound configured by the network.

For example, in the case where the WTRU (e.g., UE) may perform the NC feedback functions in the RLC layer and RLC segmentation is performed, the WTRU (e.g., UE) may send the RLC STATUS PDU if the received RLC PDU is a segment of an NC PDU/RLC SDU that is generated from a generation that n previously received NC PDUs (reassembled RLC SDUs) of similar or identical characteristics (importance, innovativeness, etc.) were generated from where n may be a parameter configured by the network within a time bound configured by the network.

For example, in the case where the WTRU (e.g., UE) may perform the NC feedback function in the PDCP layer the WTRU (e.g., UE) may send PDCP Status Report if the received PDCP PDU is generated from a generation that n previously received PDCP PDUs of similar or identical characteristics (importance, innovativeness, etc.) were generated from where n may be a parameter configured by the network within a time bound configured by the network.

According to some embodiments, the WTRU (e.g., UE) may respond to a request from the transmitter to send a status report. The status report request may include a request for a certain status report format to be used.

According to some embodiments, the WTRU (e.g., UE) may be configured with a prohibit timer to prevent sending status reports too frequently. The WTRU (e.g., UE) may start the prohibit timer when the status report is sent. The WTRU (e.g., UE) may be configured to stop and reset or not to stop and reset based on what has triggered the status report.

Some status reports may not trigger a prohibit timer or may supersede a prohibit timer. For example: a status report may be triggered because the number of received NC PDUs is greater than the NC generation size and a prohibit timer is started. Then a generation is not decoded after a certain time threshold. The WTRU (e.g., UE) (e.g., then) may send a status report even if the prohibit timer is still running as this timer is for a different purpose.

According to some embodiments, where there are multiple RLC entities and all received NC PDUs that are associated with the same generation are processed by the same RLC entity, the above trigger conditions may be applied such that one or more (e.g., each) RLC entity operates independently.

According to some embodiments, where there are multiple RLC entities and received NC PDUs that are associated with the same generation are processed by different RLC entities, the WTRU (e.g., UE) may designate one or more RLC entity/ies that will be responsible for sending the status report based on the updated trigger conditions.

According to some embodiments, the WTRU (e.g., UE) may be configured to select one RLC entity to send the status report (e.g., primary RLC entity)

According to some embodiments, the WTRU (e.g., UE) may be configured to select an RLC entity for which it may send status report based on the characteristics (type, importance, innovativeness) of NC PDUs it carries.

For example, the WTRU (e.g., UE) may be configured to send first a status report for an RLC entity carrying systematic NC PDUs.

For example, the WTRU (e.g., UE) may be configured to send first a status report for an RLC entity carrying NC PDUs with highest importance.

For example, WTRU (e.g., UE) may be configured to send first a status report for an RLC entity carrying NC PDUs with highest level of innovativeness.

According to some embodiments, the WTRU (e.g., UE) may be configured to select one or more RLC entities for which to send a status report based on the decoding requirements.

For example, the WTRU (e.g., UE) may be configured to send a status report for one RLC entity if it needs to recover one or more of missing NC PDUs at this RLC entity to recover the NC generation (e.g., the WTRU (e.g., UE) can recover the NC generation without recovering missing NC PDUs at other RLC entities).

For example, the WTRU (e.g., UE) may be configured to send a status report for more than one RLC entities if it needs to recover one or more of missing NC PDUs more than one RLC entities to recover the NC generation (e.g., the WTRU (e.g., UE) can only recover the NC generation when recovering missing NC PDUs at different RLC entities. In other words, the WTRU (e.g., UE) cannot recover the NC generation by recovering one or more of missing NC PDUs at one of the RLC entities).

Methods and procedures for sending feedback, allowing the WTRU (e.g., UE) to determine that the status report should be sent, are proposed. The WTRU (e.g., UE) may transmit the status report with information about one or more of NC PDUs that are detected to be lost, one or more NC PDUs that are successfully received, number of missing NC PDUs for a successful recovery of NC SDUs that forms the NC generation, coding coefficients to be used for a requested NC PDU, or recommended network coding parameters.

According to some embodiments, the WTRU (e.g., UE) may choose the status report format based on the information included in the status report request.

According to some embodiments, the WTRU (e.g., UE) may trigger a status report that may report the metric(s) specified in the status report request for one or more (e.g., each) generation that are being reported.

For example, the WTRU (e.g., UE) may receive an indication to report the number of missing NC PDUs for one or more (e.g., each) generation (genPDUMissingCount) included in the report as specified in the status report request.

For example, the WTRU (e.g., UE) may receive an indication to report the number of extra NC PDUs required for one or more (e.g., each) generation included in the report as specified in the status report request.

For example, the WTRU (e.g., UE) may receive an indication to report the number of required NC PDUs of certain characteristics (innovativeness, systematic vs non-systematic, etc.) for one or more (e.g., each) generation included in the report as specified in the status report request.

For example, the WTRU (e.g., UE) may receive an indication to report a common number representing the number of missing NC PDUs for one or more (e.g., each) generation included in the report as specified in the status report request, where this common number represents the maximum of all number of missing NC PDUs of the generations.

For example, the WTRU (e.g., UE) may receive an indication to report a common number representing the number of extra NC PDUs required for one or more (e.g., each) generation included in the report as specified in the status report request, where this common number represents the maximum of all number of extra NC PDUs required for the generations.

For example, the WTRU (e.g., UE) may receive an indication to report ACK/NACK status of NC PDUs from an NC PDU set (NC PDUs with specific characteristics, e.g., systematic packets).

For example, the WTRU (e.g., UE) may receive an indication to report number of missing/received NC PDUs from an NC PDU set (NC PDUs with specific characteristics, e.g., non-systematic NC PDUs)

The WTRU (e.g., UE) may receive indication to report a combination of above.

For example, the WTRU (e.g., UE) may receive indication to report ACK/NACK status of NC PDUs from NC PDU set carrying systematic packets and report number of missing packets from NC PDU set carrying non-systematic packets.

For example, the WTRU (e.g., UE) may receive indication to report ACK/NACK status of NC PDUs from NC PDU set carrying systematic packets and report number of required packets from NC PDU set carrying non-systematic packets.

According to some embodiments, the WTRU (e.g., UE) may trigger a status report that may report the generation(s) specified in the status report request.

For example, the WTRU (e.g., UE) may report the number of missing NC PDUs for the specific generation(s) (genPDUMissingCount) to be included in the report as specified in the status report request.

For example, the WTRU (e.g., UE) may report the number of extra NC PDUs for the specific generation(s) to be included in the report as specified in the status report request.

For example, the WTRU (e.g., UE) may report the number of NC PDUs of certain characteristics (innovativeness, systematic vs non-systematic, etc.) for the specific generation(s) to be included in the report as specified in the status report request.

For example, the WTRU (e.g., UE) may receive indication to report status report for NC generations with generation ID falls within indicated range in the status report request.

For example, the WTRU (e.g., UE) may receive indication to report status report for NC generations with generation ID below indicated generation ID in the status report request.

For example, the WTRU (e.g., UE) may receive indication for the first NC generation and number of NC generations after sequentially for which a status report should be reported.

According to some embodiments, the WTRU (e.g., UE) may choose a status report format based on configuration. The report method may be configured through Downlink Control Indicator (DCI), MAC Control Element (CE), layer 1 and/or layer 2 signal. According to some embodiments, the method for selecting the status report format may be pre-defined in the specification.

According to some embodiments, the WTRU (e.g., UE) may be configured with conditions for determining the status reporting format.

According to some embodiments, the WTRU (e.g., UE) may be configured to select the report format that reduces the number of reported bits in the status report.

For example, the WTRU (e.g., UE) may report the number of received NC PDUs if number of received NC PDUs is smaller than number of missing NC PDUs.

For example, the WTRU (e.g., UE) may report the number of missing NC PDUs if number of missing NC PDUs is smaller than number of received NC PDUs.

According to some embodiments, the WTRU (e.g., UE) may be configured to select the report format based on the characteristics of the NC PDU(s).

For example, the WTRU (e.g., UE) may be configured to report ACK/NACK status of systematic NC PDUs (NC PDUs belong to PDU set carrying systematic packets).

For example, the WTRU (e.g., UE) may be configured to report indices of acknowledged or unacknowledged systematic NC PDUs (NC PDUs belong to PDU set carrying systematic packets)

For example, the WTRU (e.g., UE) may be configured to report ACK/NACK status of NC PDUs belonging to an NC PDU set with importance above/below a configured threshold.

For example, the WTRU (e.g., UE) may be configured to report indices of acknowledged or unacknowledged NC PDUs belonging to an NC PDU set with importance above/below a configured threshold.

For example, the WTRU (e.g., UE) may be configured to report number of missing/received non-systematic NC PDUs.

According to some embodiments, the WTRU (e.g., UE) may choose a status report format based on the received NC PDUs. The WTRU (e.g., UE) may autonomously determine how to select a status report format, determine how to select a status report format based on network configuration, determine how to select a status report format based on a pre-defined method in the specification, etc.

For example, the WTRU (e.g., UE) may choose to report the number of NC PDUs of a certain characteristic if the WTRU (e.g., UE) determines that NC PDUs of this characteristic are needed for recovering a generation.

For example, the WTRU (e.g., UE) may choose to report the number of extra NC PDUs received that were generated from a certain generation if the number of extra NC PDUs received for this generation is above a certain threshold configured by the network.

Possible status reporting enhancements are discussed in subsequent sections. Note that all methods below may be used in addition to or in lieu of status reporting of individual packets. For example, the WTRU (e.g., UE) may perform acknowledgment with a generation granularity and negative acknowledgement with the legacy packet level granularity.

Methods and procedures are proposed allowing the WTRU (e.g., UE) to acknowledge NC generations and lists generations that are deemed unable to be recovered.

According to some embodiments, the WTRU (e.g., UE) may report the next NC generation number to be recovered and lists generations that are deemed unable to be recovered.

The status report may report the highest generation number where X NC PDUs from that generation have been received. This implicitly acknowledges all generations with a generation number less than or equal to this value unless they are (e.g., explicitly) negatively acknowledged.

According to some embodiments, the WTRU (e.g., UE) may transmit a status report that may report the generation number one above the highest generation number such that X NC PDUs from that generation have been received. This implicitly acknowledges all generations with a generation number less than this value unless they are (e.g., explicitly) negatively acknowledged. The negative acknowledgement may be done in one of several ways.

According to some embodiments, the WTRU (e.g., UE) may report the negative acknowledgement by (e.g., explicitly) listing the generation identifiers of the generation(s) where fewer than X NC PDUs (including reassembled RLC SDUs if RLC segmentation is used) have been received.

For example, in the case where the WTRU (e.g., UE) may perform the NC feedback functions in the RLC layer, the WTRU (e.g., UE) may report the negative acknowledgement by (e.g., explicitly) listing the generation identifiers of the generation(s) where fewer than X RLC SDUs (including reassembled RLC SDUs if RLC segmentation is used) have been received.

For example, in the case where the WTRU (e.g., UE) may perform the NC feedback functions in the PDCP layer, the WTRU (e.g., UE) may report the negative acknowledgement by (e.g., explicitly) listing the generation identifiers of the generation(s) where fewer than X PDCP PDUs have been received.

According to some embodiments, the WTRU (e.g., UE) may report the negative acknowledgement by (e.g., explicitly) listing the generation identifiers of the generation(s) where more than Y−X NC PDUs have been declared missing (missing packet timer expired).

For example, in the case where the WTRU (e.g., UE) may perform the NC feedback functions in the RLC layer, the WTRU (e.g., UE) may report the negative acknowledgement by (e.g., explicitly) linting the generation identifiers of the generation(s) where more than Y−X RLC SDUs (including reassembled RLC SDUs if RLC segmentation is used) have been declared missing (missing packet timer expired).

For example, in the case where the WTRU (e.g., UE) may perform the NC feedback functions in the PDCP layer, the WTRU (e.g., UE) may report the negative acknowledgement by (e.g., explicitly) linting the generation identifiers of the generation(s) where more than Y−X PDCP PDUs have been declared missing (missing packet timer expired).

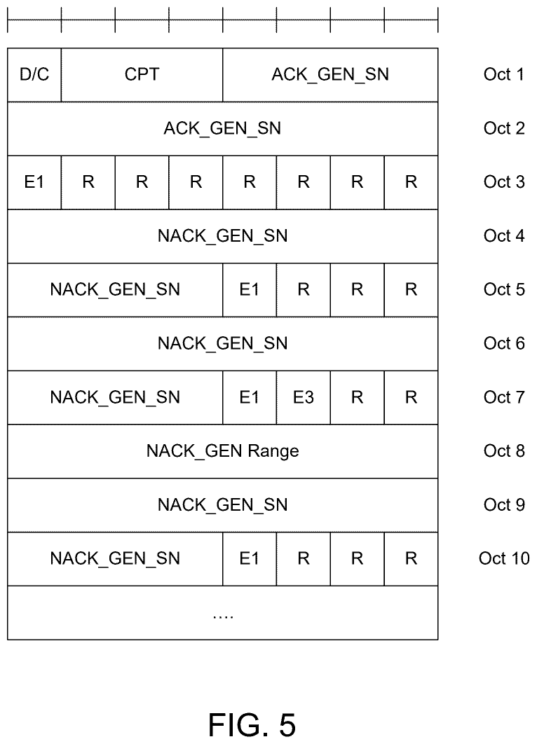

An example of this solution is shown in FIG. 5. The first bit of octet 1 may indicate that the packet is a control packet or data packet. The second, third and fourth bit are used to specify the PDU type. In this example the last 4 bits of octet 1 and all of octet 2 indicate the generation number one above the highest generation number where X NC PDUs from that generation have been received via a 12 bit generation SN. This implicitly acknowledges all generations with a generation number less than or equal to this value unless they are (e.g., explicitly) negatively acknowledged.

Octet 3 and the second half of octets 5, 7 and 10 contains 2 flags. The E1 field may indicate whether the next 12 bits contain a non-acknowledgement of a generation. The E3 field may indicate whether the non-acknowledgement of a generation will be preceded by a generation range as described below.

Octets 4 and the first half of octet 5 indicate the negative acknowledgement by (e.g., explicitly) listing the 12 bit generation SN of a generation where fewer than X NC PDUs have been received. Octet 8 (NACK GEN range) may indicate via an 8 bit integer the negative acknowledgement by (e.g., explicitly) listing the number of NC generations to be consecutively negative acknowledged starting from and including the generation specified by the 12 bit NACK_GEN_SN (Octets 9 and the first 4 bits of 10).

In this example the length of generation identifier field may be 12 bits. This value may be chosen for example and may vary. The length of the generation identifier may be the length of the PDCP SN length if segmented-SDU based NC is used as one or more (e.g., each) generation consists of segments from the same PDCP SDU. The length of the generation identifier may be the length of the PDCP SN length or less if cross-SDU based NC is used as one or more (e.g., each) generation consists multiple PDCP SDUs.

According to some embodiments, the WTRU (e.g., UE) may transmit a status report that may report the sequence number (ACK_GEN_SN) of the generation number one above the highest generation number such that X NC PDUs from that generation have been received. This implicitly acknowledges all generations with a generation number less than or equal to this ACK_GEN_SN unless they are (e.g., explicitly) negatively acknowledged. Different levels of granularity for the negative acknowledgement could be reported via the extension fields E2 and E3. For example, E2 may be used to indicate the number of missing (or required) NC PDUs for a generation, while E3 may be used to indicate a sequence of missing generations. In addition, using E2 and E3 together may be used to indicate a common number of missing (or required) NC PDUs for the indicated sequence of generations.

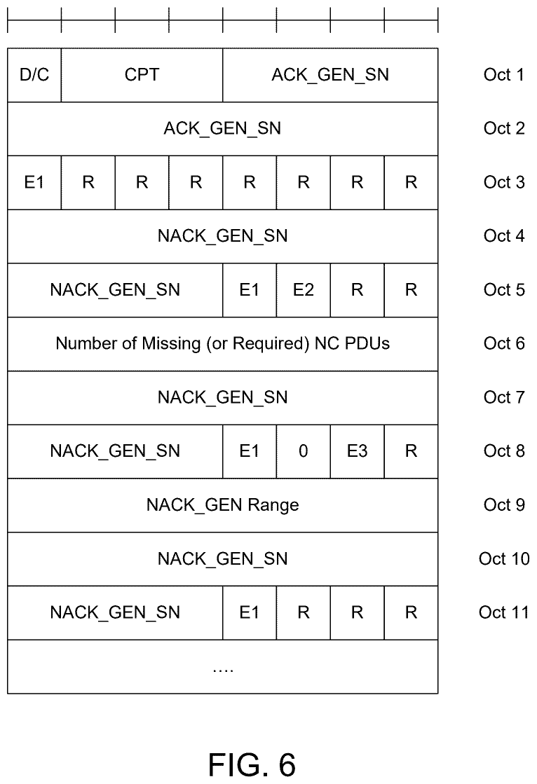

An example of this solution is shown in FIG. 6. FIG. 6 may be similar in function to FIG. 5. However, in FIG. 6, one octet (octet 6) may be used to indicate the number of missing (or required) NC PDUs for a generation to report up to 255 missing (or required) NC PDUs for a generation. The presence of the E2 flag in the second half of octet 5 may indicate that this value may be to be reported in the subsequent octet.

According to some embodiments, the WTRU (e.g., UE) may acknowledge NC generations by reporting a bitmap that may indicate the status of all NC PDUs in the receiving window.

The status report may report one or more generations, wherein at least X NC PDUs is received for one or more (e.g., each) reported generation, using a bitmap of the length of the generation reassembly window. One or more (e.g., each) bit may indicate if at least X NC PDUs from the corresponding generation have been received.

According to some embodiments, the WTRU (e.g., UE) may transmit a status report where the PDU may report one or more generations where at least X NC PDUs are received for one or more (e.g., each) reported generation, using a bitmap of the length of the generation receiver window. One or more (e.g., each) bit may indicate if at least X NC PDUs from the corresponding generation have been received.

According to some embodiments, the WTRU (e.g., UE) may (e.g., explicitly) indicate one or more (e.g., each) generation's acknowledgment and negative acknowledgement via a bitmap noting the generation(s) where fewer than X NC PDUs have been received.

For example, in the case where the WTRU (e.g., UE) may perform the NC feedback functions in the RLC layer, the WTRU (e.g., UE) may (e.g., explicitly) indicate one or more (e.g., each) generation's acknowledgment and negative acknowledgement via a bitmap noting the generation(s) where fewer than X RLC SDUs (including reassembled RLC SDUs if RLC segmentation is used) have been received.

For example, in the case where the WTRU (e.g., UE) may perform the NC feedback functions in the PDCP layer, the WTRU (e.g., UE) may (e.g., explicitly) indicate one or more (e.g., each) generation's acknowledgment and negative acknowledgement via a bitmap noting the generation(s) where fewer than X PDCP PDUs have been received.

According to some embodiments, the WTRU (e.g., UE) may (e.g., explicitly) indicate one or more (e.g., each) generation's acknowledgment and negative acknowledgement via a bitmap noting the generation(s) where more than Y−X NC PDUs have been declared missing (missing packet timer expired).

For example, in the case where the WTRU (e.g., UE) may perform the NC feedback functions in the RLC layer the WTRU (e.g., UE) may (e.g., explicitly) indicate one or more (e.g., each) generation's acknowledgment and negative acknowledgement via a bitmap noting the generation(s) where the number of missing RLC SDUs (including reassembled RLC SDUs if RLC segmentation is used) of all the generations where more than Y−X RLC PDUs have been declared missing (missing packet timer expired).

For example, in the case where the WTRU (e.g., UE) may perform the NC feedback functions in the PDCP layer the WTRU (e.g., UE) may (e.g., explicitly) indicate one or more (e.g., each) generation's acknowledgment and negative acknowledgement via a bitmap noting the generation(s) where the number of missing PDCP PDUs of all the generations where more than Y−X PDCP PDUs have been declared missing (missing packet timer expired).

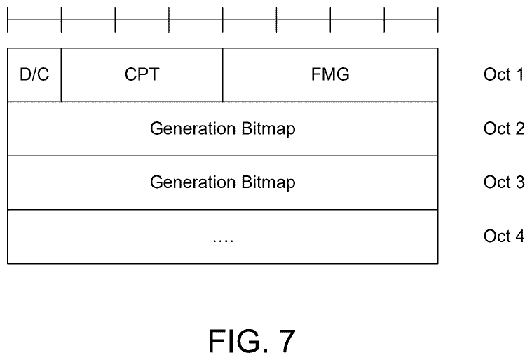

An example of this solution is shown in FIG. 7. In this example octets 2 and 3 (e.g., explicitly) indicate one or more (e.g., each) generation's acknowledgment and negative acknowledgement via a bitmap. A new parameter “first missing generation” (FMG) may be included in the example as the last 4 bits of the first octet. This parameter may specify the lower edge of the bitmap. All generations with generation sequence numbers below are implicitly acknowledged. The first bit of octet 1 may indicate that the packet may be a control packet or data packet. The second, third and fourth bit are used to specify the PDU type.

According to some embodiments, the WTRU (e.g., UE) may acknowledge NC generations and list generations that are deemed unable to be recovered and the number of NC PDUs that may (e.g., must) be transmitted to recover these generations.

The WTRU (e.g., UE) may report specific NC PDU counts for one or more (e.g., each) generation where X NC PDUs have not been received.

According to some embodiments, the WTRU (e.g., UE) may report the NC generations that require more NC PDUs to be recovered as described above and may specify the number of NC PDUs that are declared missing or the specific PDUs that are missing for one or more (e.g., each) generation in the report in addition to the negative acknowledgement. This may be used for the network to retransmit a specific amount of NC PDUs per generation and/or be used to inform the NC configuration (e.g., changes to the NC code rate).

According to some embodiments, the number of NC PDUs reported per generation may be defined as X minus the number of NC PDUs received for the generation at the time when the status report is triggered.

For example, in the case where the WTRU (e.g., UE) may perform the NC feedback functions in the RLC layer, the number of RLC SDUs reported per generation by the WTRU (e.g., UE) may be defined as X minus the number of RLC SDUs received (including reassembled RLC SDUs) for the generation at the time when the status report is triggered.

For example, in the case where the WTRU (e.g., UE) may perform the NC feedback functions in the PDCP layer, the number of PDCP PDUs reported per generation by the WTRU (e.g., UE) may be defined as X minus the number of PDCP PDUs received for the generation at the time when the status report is triggered.

According to some embodiments, the number of NC PDUs reported per generation may be defined as the number of NC PDUs have been declared missing (missing packet timer expires) for the generation at the time when the status report is triggered.

For example, in the case where the WTRU (e.g., UE) may perform the NC feedback functions in the RLC layer, the number of RLC SDUs reported per generation by the WTRU (e.g., UE) may be defined as the number of RLC SDUs (including reassembled RLC SDUs if RLC segmentation is used) have been declared missing (missing packet timer expires) for the generation at the time when the status report is triggered.

For example, in the case where the WTRU (e.g., UE) may perform the NC feedback functions in the PDCP layer, the number of PDCP PDUs reported per generation by the WTRU (e.g., UE) may be defined as X minus the number of PDCP PDUs received for the generation at the time when the status report is triggered.

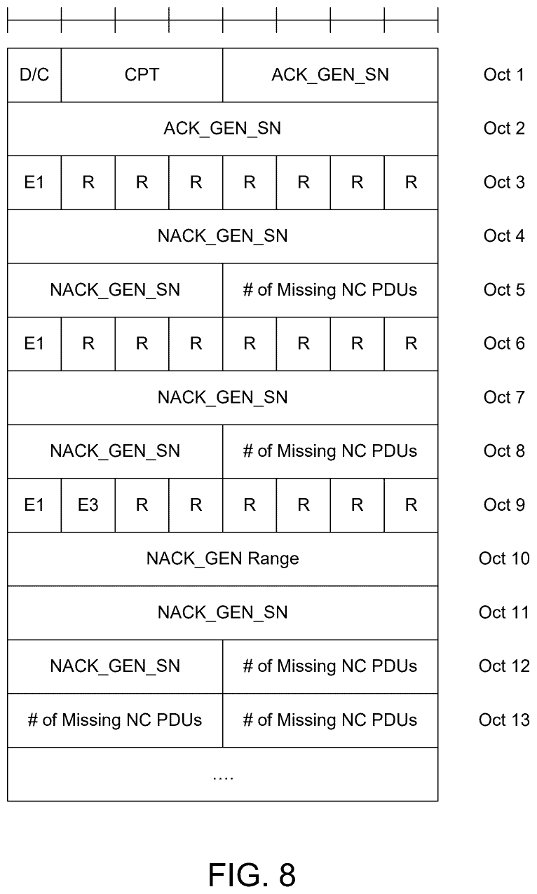

An example of this solution is shown in FIG. 8. The first bit of octet 1 may indicate that the packet may be a control packet or data packet. The second, third and fourth bit are used to specify the PDU type. In this example the last 4 bits of octet 1 and all of octet 2 indicate the generation number one above the highest generation number where X NC PDUs from that generation have been received via a 12 bit generation SN. This implicitly acknowledges all generations with a generation number less than or equal to this value unless they are (e.g., explicitly) negatively acknowledged. Octet 3 contains the “E1” flag that may indicate whether a NACK_GEN_SN follows. Octet 4 and the first half of octet 5 indicate the negative acknowledgement by (e.g., explicitly) listing the 12 bit generation SN of all a generation where fewer than X NC PDUs have been received. The second half of Octet 5 may be used to specify the 4 bit number of NC PDUs received that were generated from this generation that may (e.g., must) still be received to allow for that generation to be recovered.

Identical fields are used in octet 6-8 to report the number of packets required to recover a generation for a different generation. Octet 9 contains the “E1” flag that may indicate whether a NACK_GEN_SN follows and the “E3” flag that may indicate whether information about a continuous sequence of generations where fewer than X NC PDUs have been received. Octet 10 (NACK_GEN range) may indicate via an 8 bit integer the negative acknowledgement by (e.g., explicitly) listing the number of consecutively negative acknowledgement NC generations starting from and including the generation specified by the 12 bit NACK_GEN_SN (Octets 11 and the first 4 bits of 12). The second 4 bits of Octet 12 may be used to specify the 4 bit number of NC PDUs received that were generated from the generation specified in NACK_GEN_SN that should be sent to allow for that generation to be recovered. 4 bits are used in Octet 13 and above to specify the number of NC PDUs received that were generated the generations that are negatively acknowledged via the NACK_GEN range.

Note that other report formats (such as the bitmap shown in FIG. 7) may also be used in a similar manner where the number of NC PDUs that have been declared missing for one or more (e.g., each) generation may be (e.g., explicitly) reported for one or more (e.g., each) generation that has missing packets as per the bitmap.

According to some embodiments, the WTRU (e.g., UE) may acknowledges NC generations and may report generations for which extra packets were received.

According to some embodiments, the WTRU (e.g., UE) may transmit a status report that may report the generation number one above the highest generation number such that X NC PDUs from that generation have been received. This implicitly acknowledges all generations with a generation number less than or equal to this value. The WTRU (e.g., UE) also may specify which generation(s) extra packets were received. This may be used for the network to inform the NC configuration (e.g., changes to the NC code rate).

According to some embodiments, the WTRU (e.g., UE) may report which generation(s) extra packets were received for by (e.g., explicitly) listing the generation identifiers of all the generations where more than X NC PDUs have been received.

For example, in the case where the WTRU (e.g., UE) may perform the NC feedback functions in the RLC layer, the WTRU (e.g., UE) may report which generation(s) extra packets were received for by (e.g., explicitly) listing the generation identifiers of all the generations where more than X RLC SDUs (including reassembled RLC SDUs if RLC segmentation is used) have been received.

For example, in the case where the WTRU (e.g., UE) may perform the NC feedback functions in the PDCP layer, the WTRU (e.g., UE) may report which generation(s) extra packets were received for by (e.g., explicitly) listing the generation identifiers of all the generations where more than X PDCP PDUs have been received.

According to some embodiments, the WTRU (e.g., UE) may report the negative acknowledgement by (e.g., explicitly) listing the generation identifiers of all the generations where more than X+n NC PDUs have been received where n may be configured by the network.

For example, in the case where the WTRU (e.g., UE) may perform the NC feedback functions in the RLC layer, the WTRU (e.g., UE) may report the negative acknowledgement by (e.g., explicitly) listing the generation identifiers of all the generations where more than X+n RLC PDUs (including reassembled RLC SDUs if RLC segmentation is used) have been received where n may be configured by the network.

For example, in the case where the WTRU (e.g., UE) may perform the NC feedback functions in the PDCP layer, the WTRU (e.g., UE) may report the negative acknowledgement by (e.g., explicitly) listing the generation identifiers of all the generations where fewer more X+n PDCP PDUs have been received where n may be configured by the network.

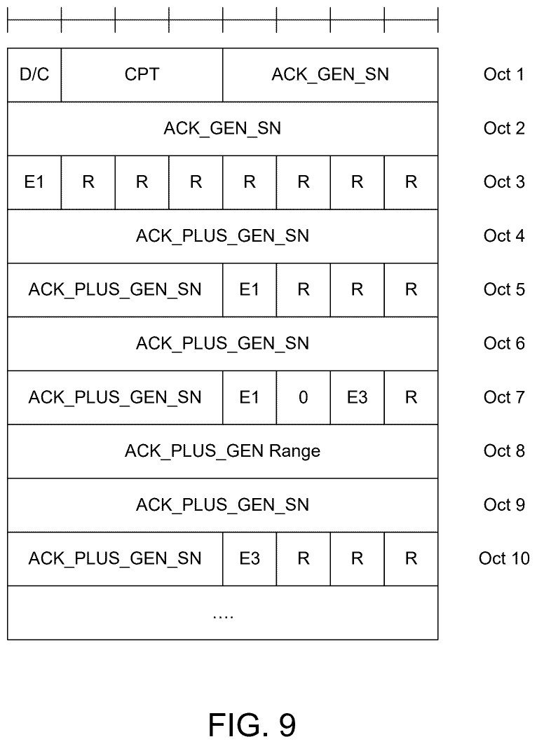

An example of this solution is shown in FIG. 9. The first bit of octet 1 may indicate that the packet may be a control packet or data packet. The second, third and fourth bit are used to specify the PDU type. In this example the last 4 bits of octet 1 and all of octet 2 indicate the generation number one above the highest generation number where X NC PDUs from that generation have been received via a 12 bit generation SN. This implicitly acknowledges all generations with a generation number less than or equal to this value and implies that all generations with a generation number less than or equal to this value have received X NC PDUs unless otherwise specified.

Octet 3 and the second half of octets 5, 7 and 10 contains 2 flags. The E1 field may indicate whether the next 12 bits contain the generation sequence number of a generation where more than X NC PDUs were received. The E3 field may indicate whether the specified generation will be preceded by a generation range as described below.

Octets 4 and the first half of octet 5 indicate the 12 bit generation SN of a generation where more than X NC PDUs have been received. Octet 8 (ACK_PLUS_GEN range) may indicate via an 8 bit integer the number of NC generations consecutively that more than X NC PDUS have been received starting from and including the generation specified by the 12 bit ACK_PLUS_GEN_SN (Octets 9 and the first 4 bits of 10).

In this example the length of the generation identifier field may be 12 bits. This value may be chosen for example and may vary. The length of the generation identifier may be the length of the PDCP SN length if segmented-SDU based NC is used as one or more (e.g., each) generation consists of segments from the same PDCP SDU. The length of the generation identifier may be the length of the PDCP SN length or less if cross-SDU based NC is used as one or more (e.g., each) generation consists multiple PDCP SDUs.

According to some embodiments, the WTRU (e.g., UE) may report the number of NC PDUs received for generations where more than X NC PDUs were received.

According to some embodiments, the WTRU (e.g., UE) may report the NC generations where more than X NC PDUs were received and specify the number of NC PDUs that were received for these generations. This may be used for the network to inform the NC configuration (e.g., changes to the NC code rate).

According to some embodiments, the number of NC PDUs reported per generation may be defined as the number of NC PDUs received per generation at the time when the status report is triggered.

For example, in the case where the WTRU (e.g., UE) may perform the NC feedback functions in the RLC layer, the number of RLC SDUs reported per generation by the WTRU (e.g., UE) may be defined as the number of RLC SDUs received (including reassembled RLC SDUs) for the generation at the time when the status report is triggered.

For example, in the case where the WTRU (e.g., UE) may perform the NC feedback functions in the PDCP layer, the number of PDCP PDUs reported per generation by the WTRU (e.g., UE) may be defined as the number of PDCP PDUs received for the generation at the time when the status report is triggered.

According to some embodiments, the number of NC PDUs reported per generation may be defined as the number of NC PDUs received per generation minus X at the time when the status report is triggered.

For example, in the case where the WTRU (e.g., UE) may perform the NC feedback functions in the RLC layer, the number of RLC SDUs reported per generation by the WTRU (e.g., UE) may be defined as the number of RLC SDUs received (including reassembled RLC SDUs) minus X for the generation at the time when the status report may be triggered.

For example, in the case where the WTRU (e.g., UE) may perform the NC feedback functions in the PDCP layer, the number of PDCP PDUs reported per generation by the WTRU (e.g., UE) may be defined as the number of PDCP PDUs received minus X for the generation at the time when the status report is triggered.

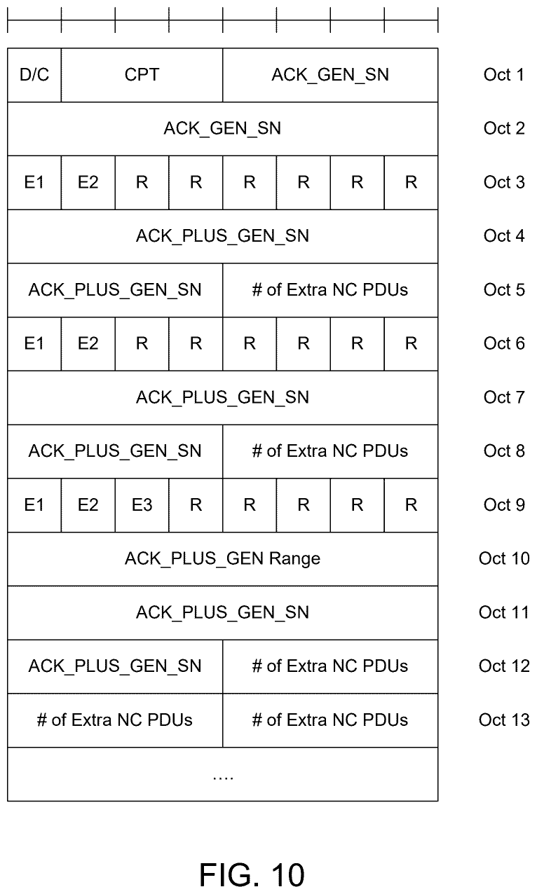

An example of this solution is shown in FIG. 10. The first bit of octet 1 may indicate that the packet may be a control packet or data packet. The second, third and fourth bit are used to specify the PDU type. In this example the last 4 bits of octet 1 and all of octet 2 indicate the generation number one above the highest generation number where X NC PDUs from that generation have been received via a 12 bit generation SN. This implicitly acknowledges all generations with a generation number less than or equal to this value and implies that all generations with a generation number less than or equal to this value have received X NC PDUs unless otherwise specified.

Octet 3 contains the “E1” flag that may indicate whether an ACK_PLUS_GEN_SN follows. Octet 4 and the first half of octet 5 indicate the extra NC PDUs received that were generated from this generation by (e.g., explicitly) listing the 12 bit generation SN of all a generation where more than X NC PDUs have been received. The second half of Octet 5 may be used to specify the 4 bit number indicating the number of NC PDUs that were received minus X (the number of NC PDUs received that were generated from this generation but are not useful in recovering the generation). The E2 flag may be used to indicate that this value will be provided.

Identical fields are used in octet 6-8. Octet 9 contains the “E1” flag that may indicate whether an ACK_PLUS_GEN_SN follows and the “E3” flag that may indicate whether information about a continuous sequence of generations where more than X NC PDUs have been received. Octet 10 (ACK_PLUS_GEN range) may indicate via an 8 bit integer the NC generations for which more than X NC PDUs have been received starting from and including the generation specified by the 12 bit ACK_PLUS_GEN_SN (Octets 11 and the first 4 bits of 12). The second 4 bits of Octet 12 may be used to specify the 4 bit number of extra NC PDUs received that were generated from the generation specified in ACK_PLUS_GEN_SN that were received. 4 bits are used in Octet 13 and above to specify the number of extra NC PDUs received that were generated from the generations that were recovered via the ACK_PLUS_GEN range. The E2 flag may be used to indicate that this value will be provided.

Note that other report formats (such as the bitmap shown in FIG. 7) may also be used in a similar manner where the number of NC PDUs that have been declared extra for one or more (e.g., each) generation may be (e.g., explicitly) reported for one or more (e.g., each) generation that has extra packets as per the bitmap.

According to some embodiments, the WTRU (e.g., UE) may report the number of NC PDUs of a certain characteristic received for specified generations.

According to some embodiments, the WTRU (e.g., UE) may report the number of NC PDUs of a certain characteristic that were received for certain generations. This may be used for the network to inform the NC configuration (e.g., changes to the NC code rate).

According to some embodiments, the number of NC PDUs of a certain characteristic reported per generation may be defined as the number of NC PDUs of a certain characteristic received per generation at the time when the status report is triggered.

For example, in the case where the WTRU (e.g., UE) may perform the NC feedback functions in the RLC layer, the number of RLC PDUs reported per generation by the WTRU (e.g., UE) may be defined as the number of RLC SDUs received (including reassembled RLC SDUs) of a certain NC characteristic for the generation at the time when the status report is triggered.

For example, in the case where the WTRU (e.g., UE) may perform the NC feedback functions in the PDCP layer, the number of PDCP PDUs reported per generation by the WTRU (e.g., UE) may be defined as the number of PDCP PDUs received of a certain NC characteristic for the generation at the time when the status report is triggered.

According to some embodiments, the number of NC PDUs of a certain characteristic reported per generation may be defined as the number of NC PDUs of a certain characteristic received per generation minus X at the time when the status report is triggered.

For example, in the case where the WTRU (e.g., UE) may perform the NC feedback functions in the RLC layer, the number of RLC SDUs reported of a certain NC characteristic per generation by the WTRU (e.g., UE) may be defined as the number of RLC PDUs received (including reassembled RLC SDUs) of a certain NC characteristic minus X for the generation at the time when the status report is triggered.

For example, in the case where the WTRU (e.g., UE) may perform the NC feedback functions in the PDCP layer, the number of PDCP PDUs of a certain NC characteristic reported per generation by the WTRU (e.g., UE) may be defined as the number of PDCP PDUs of a certain NC characteristic received minus X for the generation at the time when the status report is triggered.

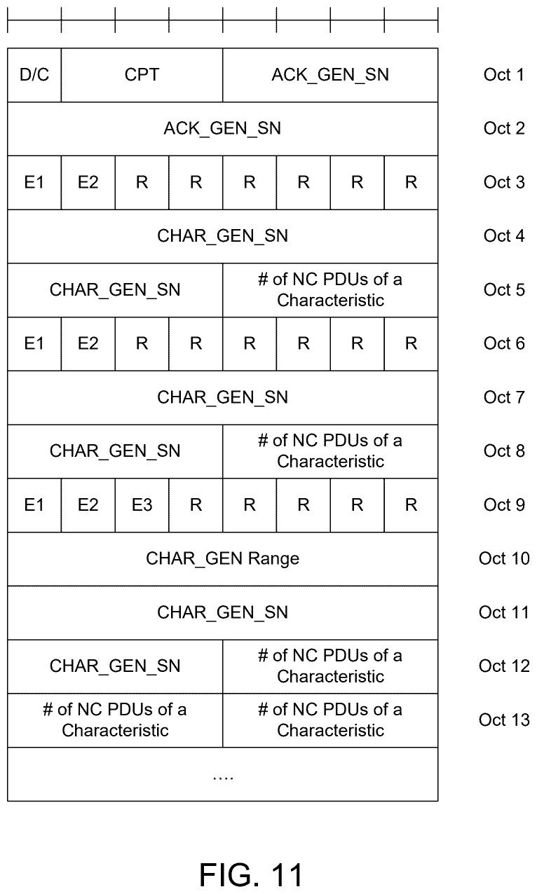

An example of this solution is shown in FIG. 11. The first bit of octet 1 may indicate that the packet may be a control packet or data packet. The second, third and fourth bit are used to specify the PDU type. In this example the last 4 bits of octet 1 and all of octet 2 indicate the generation sequence number one above the highest generation sequence number where X NC PDUs from that generation have been received via a 12 bit generation SN. This implicitly acknowledges all generations with a generation number less than or equal to this value.

Octet 3 contains the “E1” flag that may indicate whether a CHAR_GEN_SN follows. Octet 4 and the first half of octet 5 indicate the extra received NC PDUs that were generated from this generation by (e.g., explicitly) listing the 12-bit generation SN of a generation where that the number of NC PDUs of a certain characteristic are being reported for. The second half of Octet 5 may be used to specify the 4 bit number indicating the number of NC PDUs of that characteristic. The E2 flag may be used to indicate that this value will be provided.

Similar fields are used in octet 6-8. Octet 9 contains the “E1” flag that may indicate whether a CHAR_GEN_SN follows and the “E3” flag that may indicate whether information about a continuous sequence of generations where the number of NC PDUs of a certain characteristic will be reported. Octet 10 (CHAR_GEN range) may indicate via an 8 bit integer the NC generations for which the number of NC PDUs of a certain characteristic will be reported starting from and including the generation specified by the 12 bit CHAR_GEN_SN (Octets 11 and the first 4 bits of 12). The second 4 bits of Octet 12 may be used to specify the 4 bit number of NC PDUs of a certain characteristic from the generation specified in CHAR_GEN_SN that were received. 4 bits are used in Octet 13 and above to specify the number of extra received NC PDUs that were generated the generations that were recovered for all generations in the ACK_PLUS_GEN range. The E2 flag may be used to indicate that this value will be provided.

Note that other report formats (such as the bitmap shown in FIG. 7) may also be used in a similar manner where the number of NC PDUs of a certain characteristic for one or more (e.g., each) generation may be (e.g., explicitly) reported for one or more (e.g., each) generation that has extra packets as per the bitmap.

According to some embodiments, the WTRU (e.g., UE) may acknowledge NC generations and request NC PDUs with specific coefficients.

According to some embodiments, the WTRU (e.g., UE) (e.g., explicitly) may specify the coefficients of the additional NC PDUs that are being requested.

According to some embodiments, the WTRU (e.g., UE) may report coding coefficients for the additional NC PDUs by (e.g., explicitly) specifying the coding coefficients that may be used to generate additional innovative NC PDUs that the network may send.

According to some embodiments, the WTRU (e.g., UE) may report coding coefficients for the additional NC PDUs by reporting the rows of the generator matrix where the row may specify the coding coefficients that may be used to generate additional innovative NC PDUs that the network may send.

According to some embodiments, the WTRU (e.g., UE) may request specific NC SDUs by reporting NC coefficients specifying that NC SDU. This may also be viewed as a negative acknowledgement of these NC SDUs.

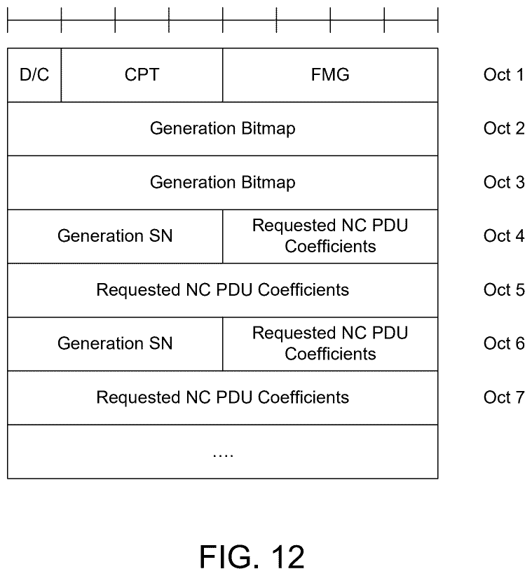

An example of this solution is shown in FIG. 12. In this example octets 2 and 3 (e.g., explicitly) indicate one or more (e.g., each) generation's acknowledgment and negative acknowledgement via a bitmap. The first half of octet 4 may be a generation sequence number specifying which generation the NC PDU is being requested for. The second half of octet 4 and all of octet 5 are a bitmap of the coding coefficients for an innovative NC PDUs that may be sent to complete the decoding of the NC generation used to generate the NC PDUs. This may be repeated in octets 6 and 7.

In this example the length of generation identifier field may be 4 bits. The length of the generation identifier may be the length of the PDCP SN length if segmented-SDU based NC is used as one or more (e.g., each) generation consists of segments from the same PDCP SDU. The length of the generation identifier may be the length of the PDCP SN length or less if cross-SDU based NC is used as one or more (e.g., each) generation consists multiple PDCP SDUs.

A new parameter “first missing generation” (FMG) may be included in the example. This parameter may specify the lower edge of the bitmap. All generations with generation sequence numbers below are implicitly acknowledged.

According to some embodiments, the WTRU (e.g., UE) may recommend updated NC configuration in status report.

According to some embodiments, the WTRU (e.g., UE) may report recommended changes to the NC configuration (such as NC code rate) by including the recommended updates to the NC configuration in the status report.

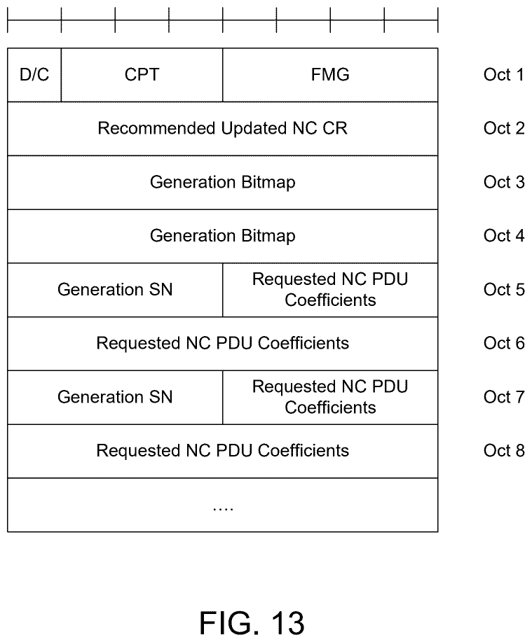

An example of this solution is shown in FIG. 13. This example may be identical to FIG. 12 except it includes a new recommend code rate in the “Recommended Updated NC Code Rate” field that may be octet 2.

According to some embodiments, the WTRU (e.g., UE) may acknowledge a specific generation via a control PDU.

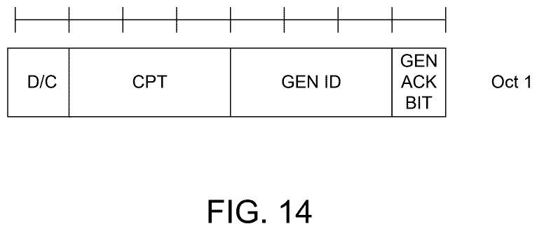

According to some embodiments, the WTRU (e.g., UE) may report the status of a specific generation via a control PDU rather than a full status report. The status report contains a generation identifier, a status bit and optionally an extra field that notes a number of NC PDUs associated with the generation such as number of NC PDUs required to decode the generation, number of extra NC PDUs received, number of NC PDUs of a certain characteristic received, etc. An example control PDU is shown in FIG. 14. Bit 0 may indicate that it may be a control PDUs, bits 1-3 indicate the PDU type, bits 4-6 indicate the generation identifier and bit 7 may indicate the recovery status of that generation.

According to some embodiments, the WTRU (e.g., UE) may report a count of the number of generations where more than X+n NC PDUs have been received.

According to some embodiments, the WTRU (e.g., UE) may report the number of NC generations where more than X+n NC PDUs were received where n may be configured by the network. This may be used for the network to inform the NC configuration (e.g., changes to the NC code rate).

According to some embodiments, the WTRU (e.g., UE) may report the number of NC generations above a threshold Z where more than X+n NC PDUs were received where n and Z are configured by the network. This may be used for the network to inform or adapt the NC configuration (e.g., changes to the NC code rate).

Methods and procedures for updating the receiving window are proposed.

In the legacy system the lower edge of the receiving window (e.g., RLC receiving window) may be (e.g., only) incremented when the NC PDU with the lowest PDU sequence number is fully received/reassembled. When NC is used not every NC PDU needs to be received as there are redundant packets that may not have to be retransmitted. If the packet is not retransmitted under the current system, the window will forever have the lower edge be the packet that is not retransmitted. To resolve this, the WTRU (e.g., UE) may (e.g., must) update the lower edge of the receiving window based on the NC configuration.

According to some embodiments, the WTRU (e.g., UE) may update the lower edge of the receiving window to be the first NC PDU of the next generation to be received based on reception of NC PDUs.

According to some embodiments, the WTRU (e.g., UE) may update the lower edge of the receiving widow by incrementing the window once at least X NC PDUs that were generated using the same generation are received. The WTRU (e.g., UE) may update the lower edge based on the NC code rate. Since there are Y output packets per generation, (e.g., then) the WTRU (e.g., UE) can increment the lower edge of the receiver by Y one or more (e.g., each) time a generation may be successfully decoded.

For example, in the case where the WTRU (e.g., UE) preforms NC feedback functions in the RLC layer, the WTRU (e.g., UE) may update the lower edge of the receiving widow (RX_Next) by incrementing RX_Next once at least X RLC SDUs (including reassembled RLC SDUs if RLC segmentation may be used) generated using the same generation are received. The WTRU (e.g., UE) may update RX_Next based on the NC code rate. Since there are Y output packets per generation, (e.g., then) the WTRU (e.g., UE) can increment the lower edge of the receiver by Y one or more (e.g., each) time a generation may be successfully decoded.

For example, in the case where the WTRU (e.g., UE) may perform NC feedback functions in the PDCP layer, the WTRU (e.g., UE) may update the lower edge of the receiving widow (RX_DELIV) by incrementing RX_DELIV once at least X PDCP PDUs generated using the same generation are received. The WTRU (e.g., UE) may update RX_DELIV based on the NC code rate. Since there are Y output packets per generation, (e.g., then) the WTRU (e.g., UE) can increment the lower edge of the receiver by Y one or more (e.g., each) time a generation may be successfully decoded.

According to some embodiments, the WTRU (e.g., UE) may update the lower edge of the receiving window to be the first NC PDU of the next generation to be received based on the acknowledged NC PDUs.

According to some embodiments, the WTRU (e.g., UE) may update the lower edge of the receiving widow by incrementing the window once a feedback report may be sent. If the report acknowledges a generation, (e.g., then) the WTRU (e.g., UE) may update the lower edge based on the number of received NC PDUs and/or the NC code rate. If the report contains a negative acknowledgement of a generation than the lower edge of the window may be incremented.

According to some embodiments, if retransmission is not performed (only additional NC PDUs are sent), (e.g., then) the lower edge of the receiving window may be incremented by the number of received and lost NC PDUs. Since no retransmission is performed, (e.g., then) both received and lost NC PDUs should be removed from the window.

For example, in the case where the WTRU (e.g., UE) may perform the NC feedback functions in the RLC layer, if retransmission is not performed (only additional NC PDUs are sent), (e.g., then) the lower edge of the receiving window (RX_Next) is incremented by the number of received and lost RLC SDUs (including reassembled RLC SDUs if RLC segmentation is used). Since no retransmission is performed, (e.g., then) both received and lost RLC SDUs should be removed from the window.

For example, in the case where the WTRU (e.g., UE) may perform the NC feedback functions in the PDCP layer, if retransmission is not performed (only additional NC PDUs are sent) (e.g., then) the lower edge of the receiving window (RX_DELIV) is incremented by the number of received and lost PDCP PDUs. Since no retransmission is performed, (e.g., then) both received and PDCP PDUs should be removed from the window.

According to some embodiments, if retransmission is performed (in addition to or in lieu of additional NC PDUs being sent), the lower edge of the window is incremented to be the lowest SN of the RLC PDU that is missing and is going to be retransmitted.

For example, in the case where the WTRU (e.g., UE) may perform the NC feedback functions in the RLC layer if retransmission is performed (in addition to or in lieu of additional RLC SDUs being sent), the lower edge of the window (RX_Next) is incremented to be the lowest SN of the RLC PDU that is missing and is going to be retransmitted.

For example, in the case where the WTRU (e.g., UE) may perform the NC feedback functions in the PDCP layer, if retransmission is performed (in addition to or in lieu of additional PDCP PDUs being sent), the lower edge of the reordering window (RX_DELIV) is incremented to be the lowest SN of the PDCP PDU that is missing and is going to be retransmitted.

According to some embodiments, if the WTRU (e.g., UE) is requesting specific NC PDUs from the BS rather than performing acknowledgement of NC PDUs/generations, the WTRU (e.g., UE) may shift the window by the number of received and lost packets. Since no retransmission is performed, (e.g., then) both received and lost packets should be removed from the window.

For example, in the case where the WTRU (e.g., UE) may perform the NC feedback functions in the RLC layer if the WTRU (e.g., UE) is requesting specific NC PDUs from the BS rather than performing acknowledgement of NC PDUs/generations, the WTRU (e.g., UE) may shift the window by the number of received and lost packets. Since no retransmission is performed, (e.g., then) both received and lost packets should be removed from the window.

For example, in the case where the WTRU (e.g., UE) may perform the NC feedback functions in the PDCP layer if the WTRU (e.g., UE) is requesting specific NC PDUs from the BS rather than performing acknowledgement of NC PDUs/generations, the WTRU (e.g., UE) may shift the window by the number of received and lost packets. Since no retransmission is performed, (e.g., then) both received and lost packets should be removed from the window.

According to some embodiments, the WTRU (e.g., UE) may update the lower edge of the receiving window to be the next generation to be received]

According to some embodiments, the WTRU (e.g., UE) has a receiving window that tracks NC generations in lieu of (or in addition to) NC PDUs. The BS will have a configured window size that is the number of generations. NC PDUs that are generated from a generation that is within the generation window are not discarded. NC PDUs that are not generated from a generation that is within the generation window are discarded.

For example, in the case where the WTRU (e.g., UE) may perform the NC feedback functions in the RLC layer, the WTRU (e.g., UE) has a receiving window that tracks NC generations in lieu of (or in addition to) RLC PDUs. The BS will have a configured window size that is the number of generations. NC PDUs that are generated from a generation that is within the generation window are not discarded. RLC PDUs that are not generated from a generation that is within the generation window are discarded.

For example, in the case where the WTRU (e.g., UE) may perform the NC feedback functions in the PDCP layer if the WTRU (e.g., UE) has a receiving window that tracks NC generations in lieu of (or in addition to) PDCP PDUs. The BS will have a configured window size that is the number of generations. PDCP PDUs that are generated from a generation that is within the generation window are not discarded. PDCP PDUs that are not generated from a generation that is within the generation window are discarded.

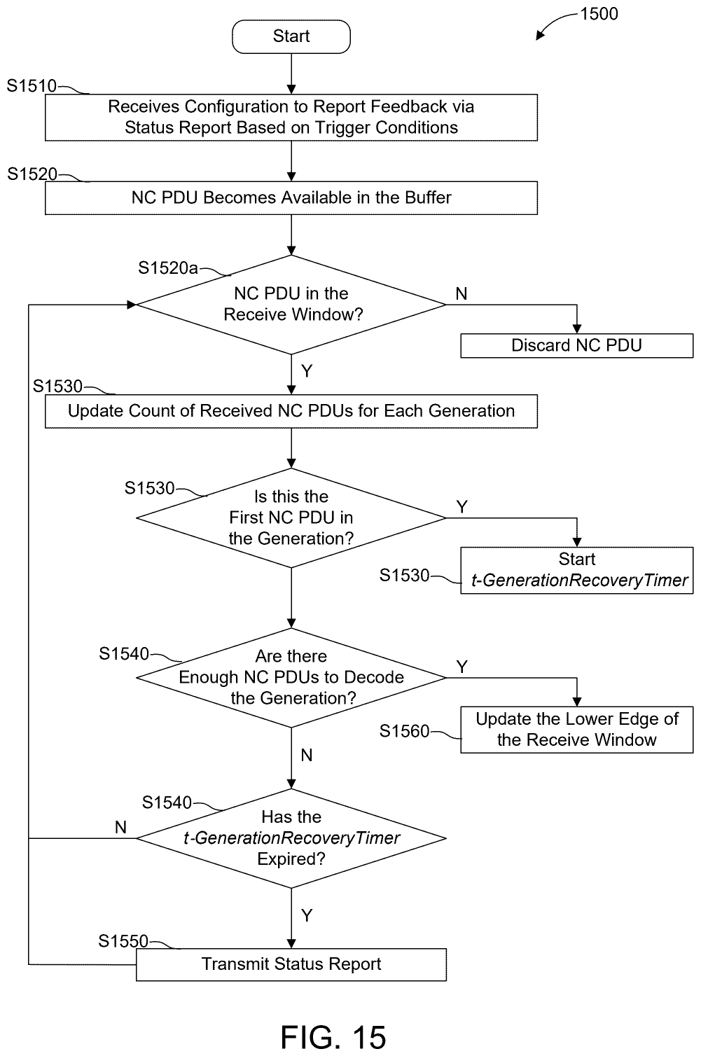

FIG. 15 is an example of a method 1500 of the WTRU (e.g., UE) sending feedback to the BS to facilitate transmission of additional NC PDUs to decode an entire generation.

The WTRU (e.g., UE) is configured with one or more values for any of: (1) NC code rate; (2) minimum number of NC PDUs required to decode the NC SDUs of the NC generation; or (3) a time duration threshold (e.g., recoveryRemainingTimeThreshold) (step S1510).

The WTRU (e.g., UE) may receive an NC PDU (step S1520).

The WTRU (e.g., UE) may determine the PDU is within the receiving window (step S1520a).

The WTRU (e.g., UE) may begin that generation's NcGenerationRecoveryTimePeriod if it is the first packet received formed from that generation and may update the count of the number of PDUs received for one or more (e.g., each) generation in the reception buffer (step S1530).

The WTRU (e.g., UE) may determine if X NC PDUs have been received for the generation that this NC PDU has been generated from (enough NC PDUs to decode the generation) and if the t-GenerationRecoveryTimer has exceeded the NcGenerationRecoveryTimePeriod (step S1540).

The WTRU (e.g., UE) may transmit the status report indicating that X−n+1 PDUs generated from this generation are missing if a status report is triggered by any of the following action: (1) indicating on a bitmap of all generations that this generation has insufficient NC PDUs; or (2) specifying the number of NC PDUs that are missing for one or more (e.g., each) generation that has been flagged as incomplete as per the bitmap (step S1550).

The WTRU (e.g., UE) may update the lower edge of the receive window such that all NC PDUs from the generation are no longer in the receive window by incrementing the window by 2X−n+1 as this is number of NC PDUs transmitted (even though not all were received) (step S1560).

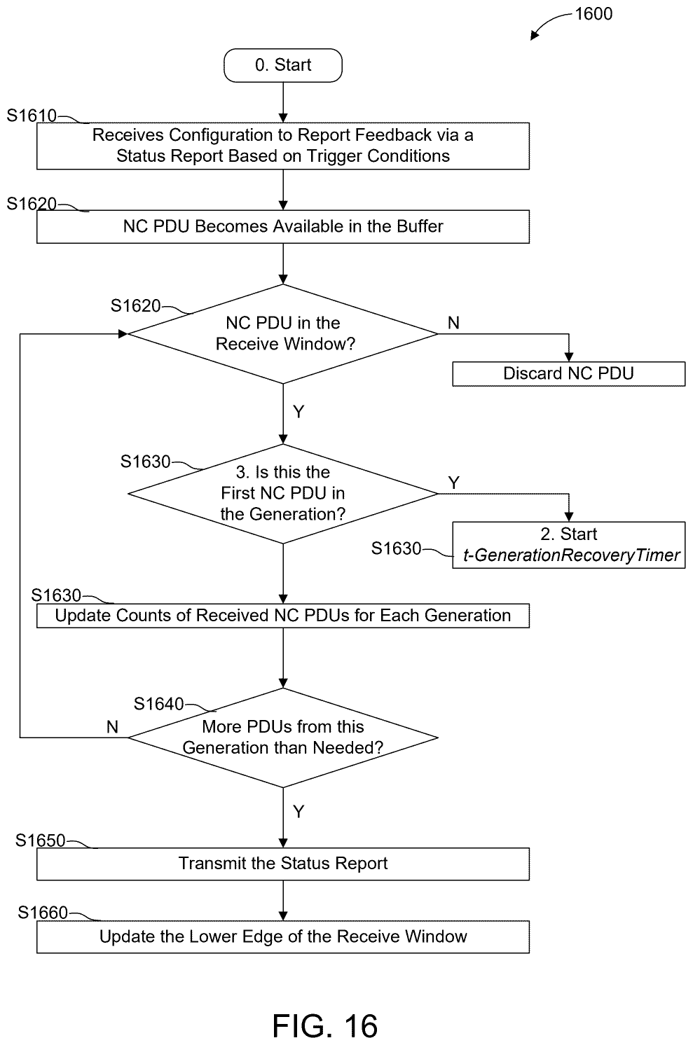

FIG. 16 is an example of a method 1600 of the WTRU (e.g., UE) sending feedback to the BS to facilitate transmission of additional NC PDUs to decode an entire generation.

The WTRU (e.g., UE) is configured with one or more value for any of: (1) NC code rate; (2) a minimum number of NC PDUs required to decode the NC SDUs of the NC Generation; or (3) a threshold that will trigger as status report when the number of NC PDUs above the minimum number of NC PDUs required to decode the NC SDUs of the NC generation (step S1610).

The WTRU (e.g., UE) may receive an NC PDU and may determine if it is within the receiving window (step S1620).

The WTRU (e.g., UE) may begin that generation's NcGenerationRecoveryTimePeriod if it is the first packet received formed from that generation and may update the count of the number of PDUs received for one or more (e.g., each) generation in the reception buffer (step S1630).

The WTRU (e.g., UE) may determine if the number of NC PDUs received for that generation has exceeded the threshold configured (step S1640).

The WTRU (e.g., UE) may transmit the status report indicating that X+m NC PDUs generated from this generation have been received where m is greater than the threshold configured (step S1650).

The status report may indicate on a bitmap of all generations that this generation has extra NC PDUs.

The status report may specify the number of NC PDUs that are extra for one or more (e.g., each) generation that has been flagged as having extra NC PDUs as per the bitmap.

The WTRU (e.g., UE) may update the lower edge of the receive window such that all NC PDUs from the generation are no longer in the receive window by incrementing the window by X multiplied the NC code rate as this is number of NC PDUs transmitted (even though not all were received) (step S1660).

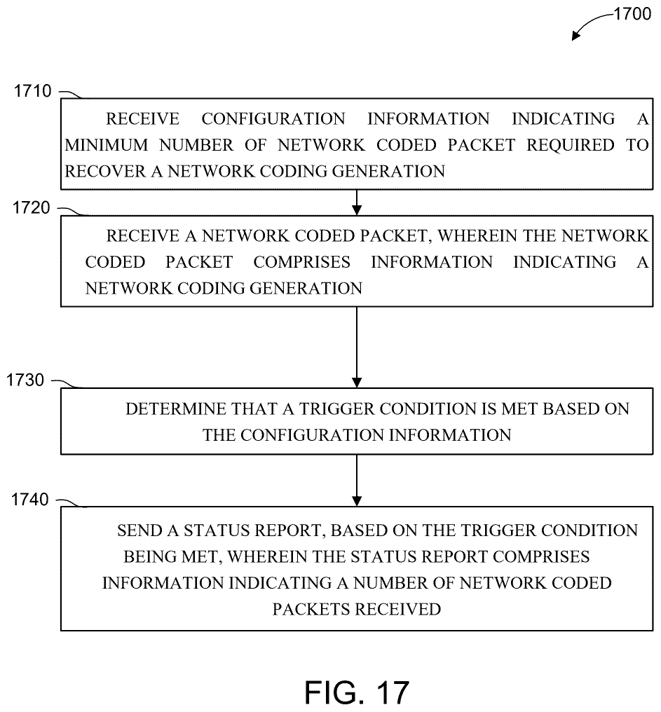

FIG. 17 illustrates an example of method 1700 of transmission of a status report implemented by a WTRU 102.

The WTRU 102 may receive configuration information indicating a minimum number of network coded packet used (e.g., required) to recover a network coding generation (step 1710).

The WTRU 102 may receive a network coded packet, wherein the network coded packet comprises information indicating a network coding generation (step 1720).

The WTRU 102 may determine that a trigger condition is met based on the configuration information (step 1730).

The WTRU 102 may send a status report, based on the trigger condition being met, wherein the status report may comprise information indicating a number of network coded packets received (step 1740).

According to certain embodiments, the network coding generation is associated with (e.g., comprises) a set of source packets being coded together.

According to certain embodiments, the configuration information may further indicate a time duration threshold and the WTRU 102 may be configured to: determine a time duration associated with the network coding generation and the number of network coded packets received, wherein the number of network coded packets may be associated with the network coding generation, and wherein the trigger condition may be met based on any of: (1) a comparison of the time duration with the time duration threshold, and (2) a comparison of the number of network coded packets received with the minimum number of network coded packets.

According to certain embodiments, the trigger condition may be met when (1) the time duration is above the time duration threshold and (2) the number of network coded packets received is below the minimum number of network coded packets.

According to certain embodiments, the trigger condition may be met when the number of network coded packets received is above the minimum number of network coded packets.

According to certain embodiments, the configuration information may further indicate a threshold value associated with a number of network coded packets missing, and wherein the trigger condition may be met when a number of network coded packets declared missing is above a threshold value, wherein the number of network coded packets declared missing is associated with the network coding generation.

According to certain embodiments, the configuration information may further indicate a characteristic associated with the threshold value; and wherein the network coded packets declared missing are associated with the characteristic.

According to certain embodiments, the characteristic may be associated with any of: (1) one or more types associated with the network coded packet, (2) one or more levels of innovativeness associated with the network coded packet, (3) one or more remaining delay budgets associated with the network coded packet, or (4) one or more priorities associated with the network coded packet.

According to certain embodiments, the status report may further comprise information indicating any of: (1) one or more network coded packets received, wherein the one or more network coded packets received are associated with the network coding generation, (2) one or more network coded packets missing, wherein the one or more network coded packets missing are associated with the network coding generation (3) one or more coding parameters associated with the network coding generation, or (4) one or more network coded packets missing associated with a characteristic, wherein the one or more network coded packets missing are associated with the network coding generation.

According to certain embodiments, the one or more coding parameters may comprise any of: (1) one or more coding coefficients, or (2) one or more coding rates.

According to certain embodiments, the configuration information may further indicate one or more first coding parameters and the WTRU 102 may be configured to: receive a further network coded packet, wherein the further network coded packet may be generated, using one or more second coding parameters indicated in the status report, and wherein the one or more first coding parameters are different from the one or more second coding parameters.

According to certain embodiments, the network coded packet may comprise information indicating a sequence number, and further comprising: determining that the sequence number may be comprised in a range of sequence numbers, wherein the range of sequence numbers may be associated with a first plurality of network coding generations and wherein the first plurality of network coding generations comprises the network coding generation.

According to certain embodiments, the WTRU 102 may be configured to update a lower limit of the range of sequence numbers based on the number of received coded packets and/or one or more coding parameters.

According to certain embodiments, the information indicating the network coding generation may comprise an identifier of the network coding generation.

According to certain embodiments, the identifier may be included in a header of the network coded packet.

According to certain embodiments, the network coding generation may be determined based on a path or a resource over which the network coded packet may be received.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method implemented by a wireless transmit/receive unit (WTRU), the method comprising:
receiving configuration information indicating a minimum number of network coded packet required to recover a network coding generation;
receiving a network coded packet, wherein the network coded packet comprises information indicating a network coding generation;
determining that a trigger condition is met based on the configuration information; and
sending a status report, based on the trigger condition being met, wherein the status report comprises information indicating a number of network coded packets received.

2. The method of claim 1, wherein the network coding is associated with a set of source packets being coded together.

3. The method of claim 1, wherein the configuration information further indicates a time duration threshold and further comprising:
determining a time duration associated with the network coding generation and the number of network coded packets received, wherein the number of network coded packets is associated with the network coding generation, and wherein the trigger condition is met based on any of: (1) a comparison of the time duration with the time duration threshold, and (2) a comparison of the number of network coded packets received with the minimum number of network coded packets.

4. The method of claim 3, wherein the trigger condition is met when (1) the time duration is above the time duration threshold and (2) the number of network coded packets received is below the minimum number of network coded packets.

5. The method of claim 1, wherein the trigger condition is met when the number of network coded packets received is above the minimum number of network coded packets.

6. The method of claim 1, wherein the configuration information further indicates a threshold value associated with a number of network coded packets missing, and wherein the trigger condition is met when a number of network coded packets declared missing is above a threshold value, wherein the number of network coded packets declared missing is associated with the network coding generation.

7. The method of claim 6, wherein the configuration information further indicates a characteristic associated with the threshold value; and wherein the network coded packets declared missing are associated with the characteristic.

8. The method of claim 7, wherein the characteristic is associated with any of: (1) one or more types associated with the network coded packet, (2) one or more levels of innovativeness associated with the network coded packet, (3) one or more remaining delay budgets associated with the network coded packet, or (4) one or more priorities associated with the network coded packet.

9. The method of claim 1, wherein the status report further comprises information indicating any of: (1) one or more network coded packets received, wherein the one or more network coded packets received are associated with the network coding generation, (2) one or more network coded packets missing, wherein the one or more network coded packets missing are associated with the network coding generation (3) one or more coding parameters associated with the network coding generation, or (4) one or more network coded packets missing associated with a characteristic, wherein the one or more network coded packets missing are associated with the network coding generation.

10. The method of claim 9, wherein the one or more coding parameters comprise any of: (1) one or more coding coefficients, or (2) one or more coding rates.

11. The method of claim 1, wherein the configuration information further indicates one or more first coding parameters and further comprising:
receiving a further network coded packet, wherein the further network coded packet is generated, using one or more second coding parameters indicated in the status report, and wherein the one or more first coding parameters are different from the one or more second coding parameters.

12. The method of claim 1, wherein the network coded packet comprises information indicating a sequence number, and further comprising: determining that the sequence number is comprised in a range of sequence numbers, wherein the range of sequence numbers is associated with a first plurality of network coding generations and wherein the first plurality of network coding generations comprises the network coding generation.

13. The method of claim 12, further comprising: updating a lower limit of the range of sequence numbers based on the number of received coded packets and/or one or more coding parameters.

14. The method of claim 1, wherein the information indicating the network coding generation comprise an identifier of the network coding generation.

15. The method of claim 14, wherein the identifier is included in a header of the network coded packet.

16. The method of claim 1, wherein the network coding generation is determined based on a path or a resource over which the network coded packet is received.

17. A wireless transmit/receive unit (WTRU) comprising circuitry, including a transmitter, a receiver, a processor and memory, the WTRU configured to:
receive configuration information indicating a minimum number of network coded packet required to recover a network coding generation;
receive a network coded packet, wherein the network coded packet comprises information indicating a network coding generation;
determine that a trigger condition is met based on the configuration information; and
send a status report, based on the trigger condition being met, wherein the status report comprises information indicating a number of network coded packets received.

18. The WTRU of claim 17, wherein the network coding generation is associated with a set of source packets being coded together.

19. The WTRU of claim 17, wherein the configuration information further indicates a time duration threshold and wherein the WTRU is further configured to:
determine a time duration associated with the network coding generation and the number of network coded packets received, wherein the number of network coded packets is associated with the network coding generation, and wherein the trigger condition is met based on any of: (1) a comparison of the time duration with the time duration threshold, and (2) a comparison of the number of network coded packets received with the minimum number of network coded packets.

20. The WTRU of claim 19, wherein the trigger condition is met when (1) the time duration is above the time duration threshold and (2) the number of network coded packets received is below the minimum number of network coded packets, or wherein the trigger condition is met when the number of network coded packets received is above the minimum number of network coded packets.
